(19) United States
(12) Patent Application Publication
(10) Pub. No.: US 2023/0012186 A1
(43) Pub. Date: Jan. 12, 2023

(54) SYSTEM AND METHOD FOR VIBROACOUSTIC DIAGNOSTIC AND CONDITION MONITORING A SYSTEM USING NEURAL NETWORKS

(71) Applicant: BOARD OF TRUSTEES OF MICHIGAN STATE UNIVERSITY, East Lansing, MI (US)

(72) Inventors: Joshua Siegel, East Lansing, MI (US); Adam Terwilliger, East Lansing, MI (US); Umberto Coda, East Lansing, MI (US)

(21) Appl. No.: 17/856,652

(22) Filed: Jul. 1, 2022

Related U.S. Application Data
(60) Provisional application No. 63/217,646, filed on Jul. 1, 2021.
(60) Provisional application No. 63/357,683, filed on Jul. 1, 2022.

(51) Int. Cl. G07C 5/08

(52) U.S. Cl. CPC G07C 5/0833; G07C 5/0808; G07C 5/008

(57) ABSTRACT

A method for diagnostic and condition monitoring of a system includes receiving data from one or more sensors, the data associated with the system; generating an audio feature based on the data; inputting the audio feature into a neural network model; and receiving one or more attribute predictions and a state prediction from the neural network model. In some embodiments, the monitored system is a vehicle and the one or more sensors are vibroacoustic sensors.

### CROSS-REFERENCE TO RELATED APPLICATIONS

This application claims the benefit of U.S. Provisional Patent Application Ser. Nos. 63/217,646 and 63/357,683, filed Jul. 1, 2021 and Jul. 1, 2022, respectively, the disclosures of which are hereby incorporated by reference in their entirety, including all figures, tables, and drawings.

### STATEMENT REGARDING FEDERALLY SPONSORED RESEARCH

None.

### FIELD

The present disclosure relates generally to the field of diagnostics, and more particularly to the technological field of systems and methods for context-based diagnostic model selection for remote or off-board diagnostics and monitoring for systems such as vehicles, appliances, etc.

### BACKGROUND

One contributor to the lifetime efficiency of an engine or vehicle is diagnostics. Diagnostic systems may precisely report faults early, helping motivate owners and operators to seek out preventative or restorative maintenance. At the same time, mobility culture is evolving, transitioning from individual vehicle ownership towards mobility-as-a-service. Given continued high mobility demands, the average vehicle age and lifetime miles traveled are increasing, particularly in developing countries, and shared mobility services, car rentals, and “robotaxis” are emerging. Increased utilization and novel use cases require enhanced fleet data generation and management capabilities. Automotive diagnostics, i.e., the inference of a vehicle's condition based on observed symptoms indicating technical state, are critical for effective fleet management.

Automotive diagnostics traditionally draw upon in-situ sensors and computation to support “On Board Diagnostics,” making use of data generated within a vehicle to diagnose the vehicle itself. Increasingly, extra-vehicular sensors—added on for diagnostic purposes, or present to enable other applications—may be used.

On-Board Diagnostic systems present on vehicles since 1996 are an automated control system utilizing distributed sensing across a vehicle's embedded systems as a technical solution for measuring vehicle operational parameters and detecting, reporting, and responding to faults. Sensors may capture signals (e.g., vibration, or noise) and algorithms extract and process features, typically comparing these “signatures” against a library of previously-labeled reference values indicating operating state and/or failure mode. If a “rule” is triggered, an indicator is set to notify the user of the fault, and additional software routines may run to minimize the impact of the fault until the repair can be completed (e.g., by changing fuel tables). On-board diagnostic data have also been used to enable indirect diagnostics, for example, using the measured rate of change of coolant temperature to infer oil viscosity and therefore remaining useful life through constitutive relationships and fundamental process physics. Certain on-board diagnostic parameters are required to be reported by the law in certain geographies. In some instances, there may be accuracy requirements. In others, parameters may not be reported or may be reported inaccurately. As a result, on-board diagnostics may not be accurate or effective.

On-board diagnostics is effective at detecting many fault classes, particularly those related to emissions. However, some failure modalities may not be detected by on-board diagnostics, or may be detected with slow response time or poor classification accuracy because: a) Incentive misalignment discourages the use of high-quality (costly) sensors, leading manufacturers to source the lowest cost sensor capable of meeting legislative standards. Relying upon the data generated by these sensors leads to “GIGO” (Garbage In, Garbage Out); b) Diagnostics may be tailored to under-report non-critical failures to improve customer satisfaction, brand perception, and reliability metrics relative to what might be experienced with an “overly sensitive” implementation; c) On-board diagnostic systems are single-purpose, meaning they correctly identify the symptoms of the faults for which they were designed, but small performance perturbations may not be detected. For example, a system designed to enhance emissions may monitor engine exhaust gas composition continuously, but will not indicate wear or component failures leading to increased emissions until a legal threshold requiring notification is surpassed.

On-board diagnostic's deficiencies are amplified by an ever aging vehicle fleet, though older cars can stand to gain the most from the incremental reliability, performance and efficiency improvement enabled by adaptive and increasingly sensitive diagnostics. While newer vehicles may have the ability to update diagnostic capabilities remotely via over-the air updates, older vehicles may lack connectivity or the computational resources necessary to implement these advanced algorithms. And while some diagnostic solutions may make use of manufacturer-proprietary data unavailable to on-board diagnostics, particularly in newer and highly-sensored vehicles, this is not universally true. Further, the sensor payload in the incumbent vehicle fleet is immutable, with no data sources added post-production—that is, the sensors installed at tie of sale are the sensors available at any point in the vehicle's life, and they are unlikely to get better with age. Therefore, the vehicles most in need of enhanced and robust diagnostics are the least-likely to support them. For these reasons, there is a need for updateable, off-board diagnostics capable of sensitive measurement, upgradeability, and enhanced prognostic (failure predictive) capabilities. A low-cost approach, even if imperfect, will enhance vehicle owners; and fleet managers' ability to detect, mitigate, and respond to faults, thereby improving fleet-wide safety, reliability, performance, and efficiency.

As the need for enhanced fleet-side utility grows, so to dies the challenge of monitoring increasingly diverse vehicles and their associated, complex subsystems. The same enhancements driving the growth of vehicle sensing and connectivity have simultaneously empowered a parallel advance: namely:, the growing capabilities of personal mobile devices. Seventy percent of the world's population is now using smartphones possessing rich sensing, high-performance computation, and pervasive connectivity—capabilities enabling a diagnostic revolution.

Pervasive connectivity enables diagnostics to utilize diverse data sources, and supports off-line processing and the creation of diagnostic algorithms capable of adapting over time. This is a result of having access to increased computational resources, enhanced storage capabilities, and richer fingerprint databases for classification and characterization. It also means that “fault definitions” may be updated at a remote endpoint, such that diagnostics may improve performance over time without requiring in-vehicle firmware upgrades (over-the-air or otherwise). To this end, mobile phone computing power has recently increased. Networking capabilities have similarly grown, allowing for inexpensive global connectivity. While some vehicles offer connectivity which may be used to support on-board diagnostics evolution, the used of third-party devices has an additional benefit to manufacturers: with mobile devices, the users not the manufacturer, pays for bandwidth and hardware capability upgrades over time. Mobile phones can augment or supplant the data generated by on-board diagnostics, fusing in-vehicle sensing with smartphone capabilities to enable richer analytics. A framework for fusing multi-source information to return actionable information has been developed, and in another case, accelerometers have been used to improve on-board diagnostics diagnostic accuracy and precision. They may even be used to enhance sensor' sampling rate to capture higher-frequency behavior reliably.

Smartphones offer clear benefits over (or in conjunction with) on-board systems, particularly when constraints such as battery life, computation, and network limitations are thoughtfully addressed, and present a compelling enhancement over automotive diagnostics' “business as usual” by offering broad diagnostics with increased sensitivity, and the ability to improve over time—whether through model upgrades, or even federated learning approaches. Though individuals have long used their smartphone inside vehicles, including plugged in and mounted, recent moves toward in-car wireless charging even more firmly establish mobile devices as incredibly powerful automotive sensing and compute devices with few constraints.

Diagnostics (e.g., based on vibroacoustics) may also be used to monitor systems and devices in other fields than the automotive field, such as, for example, factories, utilities, homes, and healthcare.

While vehicle technology is rapidly advancing, fault diagnostics are lesser-explored, whether for trained individuals (such as mechanics), or unskilled individuals (such as vehicle owners and operators). There is a largely-unmet need for a better way to understand the state of vehicles such that operators might better access the information necessary to identify and plan response to impending or latent issues. At the same time, prior work shows that bringing expert ledge to non-experts can have significant implications for fuel and energy savings as well as safety.

It would be desirable to have a system and method for vibroacoustic diagnostic and condition monitoring using context-based model selection.

### SUMMARY

In accordance with an embodiment, a method for diagnostic and condition monitoring of a system using context-based diagnostic model selection includes receiving data associated with the monitored system from one or more sensors in an off-board device, determining an identification of the system based on at least the received data, selecting an instance-specific diagnostic model based on the system identification, determining a system context based on at least the received data, selecting a context-specific diagnostic model based on the system context, and applying the selected instance-specific diagnostic model and context-specific diagnostic model to determine diagnostics and conditions of the monitored system.

In accordance with another embodiment, a system for diagnostic and condition monitoring of a vehicle using context-based diagnostic model selection includes one or more sensors, a database including a plurality of instance-specific diagnostic models and context-specific diagnostic model, and a processor device coupled to the one or more sensors and the database. The processor device includes a context-based model selection module and can be programmed to receive data associated with the monitored vehicle from the one or more sensors, determine an identification of the vehicle based on at least the received data, select an instance-specific diagnostic model from the database based on the vehicle identification, determine a vehicle context based on at least the received data, select a context-specific diagnostic model rom the database based on the vehicle context, and apply the selected instance-specific and context-specific diagnostic model to determine diagnostics and conditions of the monitored vehicle.

In accordance with a further embodiment, a method for diagnostic and condition monitoring of a system include receiving data from one or more sensors, the data associated with the system; generating an audio feature based on the data; inputting the audio feature into a neural network model; and receiving one or more attribute predictions and a state prediction from the neural network model.

In accordance with a further embodiment, a system for diagnostic and condition monitoring of a vehicle includes: one or more sensors; a memory; and a processor coupled to the one or more sensors and the memory. The processor is configured to: receive data from one or more sensors, the data associated with the monitored system; generate an audio feature based on the data; input the audio feature into a neural network model; and receive one or more attribute predictions and a state prediction from the neural network model.

### BRIEF DESCRIPTION OF THE DRAWINGS

The present invention will hereafter be described with reference to the accompanying drawings, wherein like reference numerals denote like elements.

FIG. 1 illustrates a method for context-based diagnostic model selection in accordance with an embodiment;

FIG. 2 illustrates a representative model selection process, indicating a means of identifying a vehicle variant and then selecting the most-specific diagnostic model available in order to improve predictive accuracy in accordance with an embodiment;

FIG. 3 illustrates an example method for identifying the vehicle context and using those relevant features to select an appropriate “nearest neighbor” when identifying the optimal diagnostic or prognostic model to choose in accordance with an embodiment;

FIG. 4 is a block diagram of an example system for off-board diagnostics using a method for context-based diagnostic model selection in accordance with an embodiment;

FIG. 5 illustrates an example process by which captured engine audio is split into a set of informative features, as well as exploratory data analysis used to inform classifier design in accordance with an embodiment; and

FIG. 6 illustrates an example process through which feature sets are loaded in order to test varied classification models in accordance with an embodiment.

FIG. 7 is a conceptual flowchart illustrating how a Cascading approach could perform in accordance with an embodiment.

FIG. 8 is a conceptual flowchart illustrating how a Parallel approach could perform in accordance with an embodiment.

### DETAILED DESCRIPTION

The present disclosure describes systems and methods for automated context-specific diagnostic model selection. While the present disclosure will be discussed herein in reference to an application for vehicles, it should be understood that the systems and methods for context-based diagnostic model selection may be used in connection with diagnostics and condition monitoring of other types of systems and devices including, for example, systems and devices in the home (e.g., appliances), factories, utilities and critical infrastructure, commercial spaces (e.g., heating, air conditioning, and ventilation systems), aerospace and satellite system, and healthcare.

Given the relatively poor performance of some on-board diagnostic systems and limited potential for further upgrades, there is an opportunity to use users' mobile device as “pervasive, offboard” sensing tools capable of real-time and off-line vehicular diagnostics, prognostics, and analytics. The capabilities of such tools are growing and they may soon supplant on-board vehicle diagnostics entirely, moving diagnostics from low-cost on-board diagnostics hardware frozen at time of production, to performant, extensible, and easily-upgradable hardware and adaptive software algorithms capable of improving over time. The advantage of this approach goes beyond performance improvements to increase flexibility, enabling diagnostics that address any vehicle—new or old connected or isolated—taking advantage of rich data collection, better characterizable sensors, and scalable computing. Many effective “pervasive” sensing technologies revolve around the concept of remote sensing of sound and vibration utilizing onboard microphones and accelerometers, sensors core to mobile devices. This class of sensing is termed “vibroacoustic sensing,” as it captured vibration and acoustic emissions of an instrumented system.

Vibroacoustic diagnostic methods originate from specialists troubleshooting mechanisms based on sound and feel. The vibroacoustic diagnostic method is non-intrusive, as sound can traverse mediums including air and “open” space and vibration can be conducted through surfaces without rigid mounting. It is therefore an attractive option for monitoring vehicle components. Experientially-trained mechanics may be highly accurate using these methods, though there may be future specialist shortages leading to demand for automated diagnostics.

There has been work to automate vibroacoustic diagnostics. Sound and vibration captured by microphones and accelerometers, for example, has been used as a surrogate for non-observable conditions including wear and performance level. Low-cost microphones have been used to identify pre-learned faults and differentiate normal from abnormal operation of mechanical equipment using acoustic features, providing a good degree of generalization. Like sound (which itself is a vibration), vibration has been used as a surrogate for wear with increasing intensity over time reasonably predicting time-to-failure. In fact, accelerometers have also been used to infer machinery performance using only vibration omissions as input. Vibrational analysis may be coupled with other sensing modalities, including on-board diagnostic systems, to improve diagnostic accuracy and precision, or used in lieu of onboard measurements.

Vibroacoustics, counterintuitively, may be more precise than onboard diagnostics because air gaps provide a mechanism for isolating certain sounds and vibrations from sensors. While vibration may therefore be used to capture “conductive” time-series data, acoustic signals may be preferable in certain applications as the mode of transmission may serve to pre-condition input data and may transmit information related to multiple systems simultaneously. In some applications, mechanical vibration may be more informative than sound. An example is the classification of bearing operating states in an industrial environment using vibration signals along with rough sets theory for diagnostics, yielding high classification performance using analytical methods. Some diagnostic fingerprints are developed based on understanding the underlying physical process, whereas others are latent patterns learned from experimental data collection.

Real-world systems have inputs including energy, materials, control signals, and perturbation. It is possible to directly measure inputs, outputs, and machine performance, but indirect measurement of residual processes (heat, noise, etc.) may be less-expensive and equally useful diagnostically. Vibration and sound are energy emissions stemming from mechanical interactions. Due to inherent imperfections, even precisely-manufactured and maintained rotating assemblies, such as gear meshes, may be modeled as a series of repeated impact events producing a characteristic noise or lateral motion.

If one understands these processes, it becomes possible to model them and to engineer a series of features useful for system characterization. Modelling and processing techniques include frequency analysis, cepstrum analysis, filtering, wavelet analysis, among others. These generate features that a more robust to small perturbations and therefore resistant to overfit when used in machine and deep learning algorithms. Other features describing waveforms may provide better discriminative properties. The features selected are informed by the engineer's knowledge of the physical process and what she or he believes likely to be informative in differentiating among particular states. Careful feature selection has the potential to improve diagnostic performance as well as reducing computation time, memory and storage requirements, and enhancing model generalizability.

Though vibroacoustics is a compelling solution, it requires significant and diverse training to achieve high performance and classification or gradation algorithms may be computationally-intensive and tailored to highly-specific systems. Accepting minimally-reduced performance to enhance algorithm generalizability and reduce computational performance, and/or shifting computation to scalable Cloud platforms, has the potential to make vibroacoustics more powerful as a condition monitoring and preventative maintenance tool for vehicles and other systems.

At the same time, smartphone processing power is increasing, and it may be possible to use a mobile device as a platform for real-time acoustic capture and processing, and to do the same for vibration capture and analysis.

Algorithms trained on few measurements may be inherently unstable, so multi-device crowdsourcing improves acoustic measurement classification confidence. Diverse, distributed devices lead to better training data and enhanced confidence in diagnostic results, though it is challenging to balance accuracy with system complexity and to ensure samples represent usable signals rather than background noise. These challenges can be managed with careful implementation, helping pervasively-sensed vibroacoustics attain strong performance when utilizing system-specific models for diagnostics and provide maintenance within automotive and other contexts. Example automotive application include: a) vehicle identification and component-level diagnostics; b) occupant and driver behavior monitoring and telemetry; and c) environmental measurement and context identification (e.g., road composition and state of repair). In addition to these existent applications, the present disclosure describes systems and methods to improve the vibroacoustic performance through improved contextual awareness as described further below.

Vehicles are increasingly complicated, though their mechanical embodiment typically comprises systems that translate and rotate, vibrating through use. There is a corpus of prior development focused on analysis of such systems. In one example, an automated means of extracting robust features from rotating machinery was developed, using an auto-encoder to find hidden and robust features indicative of operating condition and without prior knowledge or human intervention. Mechanical systems wear down, leading to different operating states that a diagnostic tool must be able to detect in order to time preventive maintenance properly. To address this need, a “sound detective” was developed to classify the different operating states of various machines.

In another example, a prior approach to vibrational analysis utilizes constrained computation and embedded hardware. A Raspberry Pi was used to diagnose six common automotive faults using deep leaning as a stable classification method (relative to decision trees), comparing four neural network architectures. It is unclear how these results generalize to other vehicle types and configurations, and whether they are less-sensitive to small data perturbations than other techniques. The use of a constrained system demonstrates the potential scalability of vibroacoustic approaches to mobile devices and those with similar capabilities.

Automotive engines, as with other reciprocating machinery, may be difficult to diagnose because of the coupling among subsystems. Engines generate sound stemming from intake, exhaust, and fans, to combustion events, valve-train noise, piston slap, gear impacts, and fuel pumping. Each manifests uniquely and transmits across varied transmission pathways. For this reason, audio may be more suitable than vibration for identifying faults as the air-transmission path eliminates some system-coupling, making it easier to disaggregate signals.

It may be difficult to select the appropriate degree of abstraction in generating reference features, and a highly-abstracted vibroacoustic emission model for diagnostics has been developed. In many studies, complete and accurate physical fault models are not available, so signal processing and machine learning techniques help improve classification performance. There are techniques for signal decomposition to better-highlight and associate features with significant engine events, and it may be possible to guise classification tools through created feature engineering including time-frequency analysis, or wavelet analysis.

Sensing engines can be done on resource-constrained devices and still enable continuous monitoring, with hardware-agnostic algorithm implementations. Another example of a prior technique used an Android mobile device to record vehicle audio, create frequency and spectral features, and detect engine faults by comparing recorded clips with reference audio files, where the developers could detect engine start, drive belt issues, and excess valve clearance.

Engine misfiring is typical within older vehicles die to component wear. Misfires have been detected in a contact-less acoustic method with 94% accuracy, relative to 82% accuracy attained from vibration signals. Without opening the hood and recording at the exhaust, the developers reached 85% classification accuracy from audio (which again outperformed vibration). While some algorithms have been developed without physical process knowledge, other make use of system models to improve diagnostic performance. Use of aspects of the physical model can help reduce algorithm complexity, requiring a feature engineering work before analyzing the input data.

In another prior technique, feature extraction was used to reach 99% fault classification accuracy in a study of misfire, well exceeding other prior techniques. This technique demonstrates that feature selection and reduction techniques based on Fisher and Relief score are effective at improving both algorithm efficiency and accuracy, as well as the concept of “Pareto Data”—data captured from low-quality sensors that have the potential to deliver high value when appropriately processed. In this case, data were collected from a commodity smartphone microphone. Similar acoustic data and engineered features have been successfully used to monitor the condition of engine air filters, helping to precisely time change events without the need for costly, high-fidelity, calibrated sensors.

In some example feature engineering techniques, such as wavelet packet decomposition used in the misfire and air filter techniques described above, have found application in other engine diagnostic contexts such as identifying excessive engine valve clearance and combustion events. Other common faults relating to failed engine head gaskets, valve clearance issues, main gearbox, joints, faulty injections and ignition components can also be detected thanks to vibrational analysis. Transmission, too, may be monitored, and a damaged tooth in a gear can be diagnosed capturing sound and vibration at a distance. Even high-speed rotating assemblies, such as turbochargers can be monitored—turbocharging is increasingly common to meet stringent economy and emissions standards, and engine compression surge has been identified and characterized by sound and vibration.

Non-automotive engines and fuel type can also be identified using vibroacoustic approaches. Smartphone sensors may be used to classify normal and atypical adjustments of tractor engines with 98.3% accuracy, and fuel type can be determined based on vibrational mode—with 95% accuracy.

Other prior techniques have used physics to guide feature creation for indirect diagnostics, e.g., measuring one parameter to infer another. For example, in one prior technique the developers used engine temperature over time as a surrogate measure for oil viscosity and found promising results relating dT/dt to viscosity. As it turns out, vibration may be used as further abstraction. By measuring engine vibration one may determine the engine speed (RPM) and it may be possible to determine whether the car is in gear to identify when the car is at rest. Using knowledge of the car's warm up procedure (which typically involves so called “fast idle” until the engine warms up to temperature, to reduce emissions), it may be possible to time how long it takes to go from fast idle (where the engine runs quickly to warm up and therefore reduce emissions) to slow idle and infer temperature from vibration, thereby creating a means of inferring oil viscosity from vibration alone and without the use to onboard temperature data.

Prior mobile application have been developed for minimizing the knowledge gap between vehicle operators and expert mechanics. In one example, sound may be used to improve diagnostic precision relative to that of untrained users. Intelligence may be embedded in a mobile application wherein a user uploads a recording of a car and answers related questions to produce a diagnostic result. The application works by reporting the label of the most-similar sample in a database as determined by a convolutional neural network (VGGish model). Peak diagnostic accuracy is 58.7% when identifying the correct class from twelve possibilities.

Algorithms have the most value when they are transferrable, as they can be trained on one systems and applied to another with high performance. In an example, transferability across similar engine geometries of different cars may be considered in the context of detecting piston and cylinder wear, and measuring valve-rain and roller bearing state.

Powertrain diagnostics are important, but it is equally important to instrument other vehicle subsystems. Offboard diagnostics may be applied to vehicle suspensions as a means of improving performance, safety, and comfort.

As with powertrain diagnostics, suspensions may be monitored using vibroacoustic analysis, optical and other methods, or a combination of both. In terms of vibroacoustics, wireless microphones have been used to monitor wheel bearings and identify defects based on frequency domain features, and vibration analysis has been implemented to detect remaining useful life of mechanical components such as bearings. Similar data and algorithms have been exploited to identify the emergence of cracks in suspension beams.

Other vibroacoustic approaches have been implemented using accelerometers and GPS to measure tire pressure, tread depth, and wheel imbalance, primarily using frequency-based features. Such solutions could be extended to instrumenting brakes, using frequency features and low-pass acceleration to measure specific pulsations occurring only under braking, or gyroscopes, to measure events taking place only when turning (or driving in a straight line).

As mentioned above, prior studies have demonstrated a means of diagnosing six vehicle component faults using vibration and Deep Leaning Diagnostics algorithms running within constrained compute environments. Some of these diagnostics target wheels and suspensions, specifically at wheel imbalance, misalignment, brake judder, damping loss, wheel bearing failure, and constant-velocity joint failure. Each fault may be selected as manifesting with characteristic vibrations and occurring at different frequencies. This technique required vehicle to be driven at particular speeds in order to maximize signal. Accuracy varies, with a peak Matthew Correlation Coefficient of 0.994—however, a small sample size and randomly-generated datasets with replacement may lead to overfit, artificially heightening the reported performance.

Aside from accelerometers and GPS, other sensor measurands have been explored in the context of suspension diagnostics, with classification and gradation algorithms making use of sensors including mobile phone cameras. In one application, smartphone cameras may be used to identify tire degradation resulting from oxidation and cross-linking failures based on the appearance of characteristic patterns identifiable with a convolutional neural network. In this application, the concept of “embedded intelligence” was used, which took specialized knowledge (knowledge both that tires degrade over time, and the method through which degradation manifests and becomes visible) and built it into a tool deployable across hardware variants and requiring no training to operate effectively. The existence of the application itself made vehicle owners and operators aware of potential risks and fault modalities, and brought expert-level assessment to the hands of any user with a mobile device with a camera and internet connection.

Recent studies have utilized MEMS accelerometers to investigate vehicle vibration indicative of vehicle body state and condition. Specifically, MEMS accelerometers allow the diagnosis of articulation events in articulated vehicles, e.g. buses. In one study, sensors were placed within the vehicle, with one located within each of the two vehicle segments in order to detect articulation events and monitor changes in bearing play resulting from wear and indicating a need for maintenance.

Vehicle occupants value fit and finish and a pleasant user experience while riding in a vehicle. To this end, there is an unmet need for realtime noise, vibration, and harshness (NVH) diagnostics. Vibroacoustics and other offboard techniques may find application in identifying and remediating the source of squeaks, rattles, and other in-cabin sounds in vehicles after delivery from the factory.

Beyond monitoring vehicle condition and maintenance needs, offboard diagnostics have the potential to identify vehicle operating state in realtime, e.g. to identify whether a vehicle is moving or not, the position of the throttle, steering, or braking controls, or in which gear the selector is currently placed. To this end, mobile devices can be used to enable sensitive classification algorithms making use of accelerometers and cameras.

At their simplest, mobile devices may be used to detect mode of transit, such as whether someone is in a car and driving. Some context-aware applications use sensor data to detect whether a vehicle is moving, and if so, to undertake appropriate actions and adaptations to enhance occupant safety, e.g. by disabling texting while in motion. The aforementioned study made use of accelerometers to supervise and eliminate false positive events from the training dataset, ultimately yielding a performance with 98% specificity and 97% sensitivity.

Others have used similar data to detect the operating state of a vehicle in order to identify lane changes or transit start- and end-points, using smartphones. The overall accuracy attained depends on the algorithm used and classification label, but ranges from 78.3% to 88.6% for one tree-bagging method.

Vehicle operating state may also be monitored and various areas of development which are being explored include:
1. Accelerometer-based accident detection and response, for example, smartphones may be used to detect and respond to incidents taking place on all-terrain vehicles and capable of differentiating “normal” driving from simulated accidents with over 99% confidence. Some approaches use these data to automate rerouting.
2. Mobile phone cameras may be used to detect a vehicle's distance to leading traffic, providing realtime contextual information and situational awareness while affording older vehicles the benefits of modern (and typically expensive) advanced driver assistance systems.
3. Using K-means clustering with acceleration data to identify driving modes, such as idling, acceleration, cruising, and turning as well as estimating fuel consumption (there are multiple methods for using mobile sensors as surrogate data to indirectly estimate fuel consumption).
   Another example application of pervasive sensing and offboard diagnostics is to occupant state and behavior monitoring.

Many automotive incidents resulting in injury or harm to property result from human activity. It is therefore essential to monitor not only the state and condition of a vehicle, but also to supervise the driver's state of health and attention in order to reduce unnecessary exposure to hazards and to promote safe and alert driving.

Occupant monitor (including drivers and passengers) may be grouped broadly into three categories:
1. Occupant State, namely health and the capacity to pay attention to and engage with the act of driving.
2. Occupant Behavior, namely the manner of driving, including risks taken and other parameters informing telemetry, e.g. for informing actuarial models for insurers or for usage-based applications.
3. Occupant Activities, namely the actions taken by occupants within the vehicle (e.g. texting), with particular application to preventing or mitigating the effects of hazardous actions.

Vehicle occupant state may be monitored for a variety of reasons, e.g. related to drowsiness, drunkenness, or drugged behavior. Mobile phones may be used to detect and report drunk driving behavior, with accelerometers and orientation sensors informing driving style assessments indicative of drunkenness. In another example, mobile device camera images may be used to measuring occupant alertness. Drowsiness may also be monitored using smartphone data, helping to inform ADAS systems.

The main issue with occupant state may be related to drunk driving state. With mobile phones placed in the vehicle there may be the opportunity to detect that particular condition observing both the driving style (using accelerometers and orientation sensors) and the driver alertness monitoring the eye state with mobile device camera. As with vehicle diagnostics, multiple sensor types may be used to monitor driver state.

Counterintuitively, as highly automated driving grows in adoption, there will be growing demand for occupant metrics—at first, to ensure that drivers are “safe to drive,” and later, to make judgments as to how much to trust a driver's observations and control inputs relative to algorithms, e.g. to trust a lane keeping algorithm more than a drunk driver, but less than a sober driver.

Smartphones have been widely deployed in order to develop telematics applications for vehicles and their occupants, using exterioceptive sensing to support “off board supervision”. These data may be used by insurance companies to monitor driver behaviors and to develop bespoke policies reflecting real-world use cases, risk profiles, and driver attitudes.

One example prior study explores the performance of smartphone-derived data as it relates to algorithm performance, device capabilities, power consumption, positioning accuracy, and driver behavior, as applied to travel mode, time and routing, maneuvering, aggression, eco-friendliness, and reactiveness, all of which are critical to informing telemetry algorithms such as vehicle tracking or insurance.

Pervasively-sensed data may be used in three main insurance contexts, helping to:
1. Monitor a driver and/or vehicle's distance traveled, supporting usage-based insurance premiums.
2. Supervise eco-driving, using metrics such as vehicle use or driver behavior (including harshness of acceleration and cornering, with demonstrated performance achieving more than 70% accurate prediction) to guide more-conservative behavior. Related to this, vehicle speed can be monitored with smartphone accelerometers alone, with an accuracy within 10 MPH of the ground truth.
3. Observe driver strategy and maneuvering characteristics, to assess actuarial risk and feed models with real-world data to inform premium pricing. This information may be used as input into learned statistical models representing drivers, vehicles, and mobile devices to detect risky driving maneuvers. Notably, driving style and aggression level can be detected with inexpensive multi-purpose mobile phones and vehicles or drivers may be tracked to identify the potential for high risk operation, in cases with no additional sensors installed in the vehicle.

Other behavior monitoring and telemetry use cases may relate to safety, providing intelligent driver assistance by estimating road trajectory, using smartphones to measure turning or steering behavior (with 97.37% accuracy), classifying road curvature and differentiating turn direction and type, or offering even-finer measure of steering angle to detect careless driving or to enhance fine-grained lane control. Some mobile phone data may identify driving events in order to inform path planning algorithms. In an example, straight driving, stationary, turning, braking, and acceleration behaviors may be identified independently on the orientation of the device. These approaches may use several learning approaches, though many use end-to-end deep learning framework to extract features of driving behavior from smartphone sensor data.

Human activity recognition has been widely studied outside vehicular contexts, and the performance of such studies suggest a likely transferrability to vehicular environments, with pervasive (ambient) or human monitoring gaining prominence. In the present disclosure, in-vehicle and non-vehicular activity recognition may be considered.

In the present disclosure, three categories of “off-board” sensing for human activity recognition may be considered:
1. In vehicle activity recognition: Similarly to the use of pervasive sensing for drunk driver detection, mobile sensing may be applied to the recognition of non-driving behaviors within vehicles, for example distracted driving and texting-while-driving. Detecting texting-while-driving may be based upon the observation of turning behavior, as measured by a single mobile device. Mobile sensing solutions making use of optical sensors may also be demonstrated to detect driving context and identify potentially-dangerous states. A survey of smartphone-based sensing in vehicles may be used for activity recognition within vehicles including driver monitoring and the identification of potentially-hazardous situations.
2. Workshop activity recognition: Human-worn microphones and accelerometers may be used to monitor maintenance and assembly tasks within a workshop, reaching 84.4% accuracy for eight-state task classification with no false positives. In another example, similar sensors may be used to differentiate class categories included sawing, hammering, filing, drilling, grinding, sanding, opening a drawer, tightening a vice, and turning a screw driver using acceleration and audio data. For user-independent training, one example study attained recall and precision of 66% and 63% respectively/. The methods demonstrated in identifying different work- and tool-use contexts may provide the basis for identify human engagement with various vehicle subcomponents, e.g. interaction with steering wheels, pedals, or buttons, helping create richer “diagnostics” for vehicle occupants and their use cases.
3. General activity recognition: Beyond identifying direct human-equipment interactions, mobile sensing may be applied to the creation of context-predictive and activity-aware systems. Wearable sensors and mobile devices with similar capabilities may be used to detect user activities including eating, drinking, and speaking, with a four-state model attaining in-the-wild accuracy of 71.5%. In another study, user tasks may be identified over a 10-second window with 90% activity recognition rate. In vehicles and mobile devices, computation is often constrained. Activity classification may be performed using microphone, accelerometer, and pressure sensor from mobile devices in a low-resource framework. This algorithm was able to recognize 15-state human activity with 92.4% performance in subject-independent online testing.

Related to tailoring user experience, acoustic human activity recognition is an evolving field aimed at improving automotive Human Machine Interfaces (HMI) suitable across contexts. In one example study, 22 activities were investigated and a classifier was developed reaching an 85% recognition rate. Acoustic activity recognition may also be applied directly to general activity detection.

In consumer electronics, activity or context recognition may be used to detect appliance use or to launch applications based on context, or used as sound labeling system thanks to ubiquitous microphones. Sound labeling and activity/context recognition may help augment classification approached by defining a context (environment) in order to limit the set of classes to be recognized before classifying an activity based on available mined datasets. In one sample application, 93.9% accuracy was reached on prerecorded clips with 89.6% performance for in-the-wild testing. The demonstrated system was able to attain similar-to-human levels of performance, when compared against human performance using crowd-sourcing service Amazon Mechanical Turk. In another example study, human feedback may be used to provide anchor training labels for ground truth, supporting continuous and adaptive learning of sounds.

Detecting activities within a vehicle—using acoustic sensing or other approaches—may help to tailor the vehicle user experience based on real-time use cases. Using techniques for general activity recognition and applying this to an automotive context has the potential to improve the occupant experience as well as vehicle performance and reliability. Of course, monitoring vehicles and their occupants alone does not yield a comprehensive picture of a vehicle's use case or context: the last remaining element to be monitored is the environment.

Environment monitoring is a form of off-board diagnostic that may help to disaggregate “external” challenges from problems stemming from the vehicle or its use, e.g. in separating vibration stemming from cracks in the road from vibration caused by warped brake rotors. Environment monitoring is also a crucial step towards autonomous driving, helping algorithms understand their constraints and operate safely within design parameters.

Already, smartphones can be used as pervasive sensors capable of complementing contemporary ADAS implementations. In one example study, vehicle parameters recorded from a mobile device accelerometer may be used to measure road anomalies and lane changes. Vibroacoustic and other pervasively-sensed measurements may also be used for environment analysis. These may be used to calibrate ADAS systems by monitoring road condition, to classify lane markers or curves, to measure driver comfort levels, and as traffic-monitoring solutions. Some example pervasively-sensed environment monitoring approaches are described as follows:
Pavement road quality can be assessed by humans, though mobile-only solutions may be lower-cost, faster, or offer broader coverage. Accelerometers may be used for detecting defects in the road such as potholes or even road surface type (e.g. gravel detection, to adapt antilock braking sensitivity) or speed bump locations. Road-surface materials and defects may also be detected from smartphone-captured images using learned texture-based descriptors. It is also relevant to consider the weather when monitoring the road surface condition for safety, and microphone-based systems have demonstrated performance in detecting wet roadways. Captured at scale, smartphone data may be used to generate maps estimating road profiles, weather conditions, unevenness, and mapping condition more precisely and less expensively than traditional technique, with enhanced information perhaps improving safety. These data may be used to report road and traffic conditions to connected vehicles.
Curve data and road classification may integrate with GPS data to increase the precision of navigation system. Mobile phone IMU's have been used to differentiate left from right and U-turns, and it is reasonable to believe that combining camera images with IMU data (and LiDAR point clouds, if available), may help to generate higher-fidelity navigable maps for automated vehicles.
The comfort level of bus passengers has been investigated with mobile phone sensors, attaining 90% classification accuracy for defined levels of occupant comfort.
Mobile sensing may be used to detect parking structure occupancy.
Acoustic analysis of traffic scenes with smartphone audio data may be used to classify the “busyness” of a street, with 100% efficacy for a two-state model and 77.6% accuracy for a three-state model. Such a solution may eliminate the need for dedicated infrastructure to monitor traffic, instead relying on user device measurements. In an example, developers implemented a 10-class model, classifying environments based on audio signatures indicating energy modulation patterns across time and frequency and attaining a mean accuracy of 79% after data augmentation. Audio may also be used to estimate vehicular speed changes, and vibration may be, as well—using a convolutional neural network to estimate speed while eliminating the drift typically associated with double-integrating accelerometer data.
Offboard sensors lead many lives—as phones, game playing devices, and diagnostic tools—so it is important for devices to be able to identify their own mobility use context. One example approach uses mobile device sensors and Hidden Markov Models to detect transit mode, choosing among bicycling, driving, walking, e-bikes, and taking the bus, attaining 93% accuracy, which may be used to create transit maps and/or to study individuals' behaviors.

Though the described approaches relate primarily to cars, trucks, and busses, many solutions apply to other vehicles as well. Off-board diagnostics for additional vehicle classes are described below.

Off-board and vibroacoustic diagnostics capabilities may be used for non-automotive, truck, or bus-type vehicles, including planes, trains, ships, and more:
As with cars, train suspensions and bodies may be instrumented using vibroacoustic sensing. Train suspensions may be instrumented and monitored using vibrational analysis. Brake surface condition may also be monitored with vibroacoustic diagnostics. Train bodies (NVH) may also be monitored, notably the doors on high-speed trains. Their condition may be inferred with the use of acoustic data.
Aerial vehicle propellers are subjected to high rotational speeds. If imbalanced or otherwise damaged, measurement of the resulting vibrations may lead to rapid fault detection and response.
In maritime environments, vibroacoustic diagnostics may be implemented with the use of virtualized environments and virtual reality to allow remote human experts with access to spatial audio and body-worn transducers to diagnose failures remotely.

The present disclosure describes systems and methods for context-based diagnostic model selection that may utilize vibroacoustic diagnostic, pervasive sensing and shared mobility. In some embodiments, the systems and methods may use mobile device sensors alone, or use such offboard sensors to compliment in-vehicle hardware. In some embodiments, the offboard sensors may be implemented in a wearable device. In some embodiments, the sensors may be integrated into the measured and monitored system.

Often, classification relies upon generalizable models to ensure the broadest applicability of an algorithm, perhaps at the expensive of performance. Occasionally, classifiers—such as activity recognition algorithms—may make use of “personalized” models. Personal Models are trained with a few minutes of individual (instance-specific) data, resulting in improved performance. This approach may be extended from activity recognition to off-board vehicle diagnostics, with the creation of instance- or class-specific diagnostics algorithms. Selecting such algorithms may therefore first require the identification of the monitored instance or class.

The present disclosure describes a context-based model selection system and method, aimed at identifying the instrumented system precisely such that tailored models may be used for diagnostics and condition monitoring.

Differentiating among, for example, makes, models, and use contexts for a monitored system (e.g., a vehicle, appliance, ventilation system, etc.), may allow tailored classification algorithms to be used, with enhanced predictive accuracy, noise immunity, and other factors—thereby improving diagnostic accuracy and precision, and enabling the broader use of pervasive sensing solutions in lieu of dedicated onboard systems.

Automotive enthusiasts can detect engine types and often specific vehicle makes and models from exhaust notes alone—and researchers have demonstrated success using computer algorithms to do the same, recording audio with digital voice recorders, extracting features, and testing different classifiers—finding that it is possible to use audio to differentiate vehicles. The more the application knows or infers about the instrumented system, the more accurate the diagnostic model implemented may become.

In some embodiments, a contextual identification system and model selection tool may be configured to improve diagnostic accuracy and precision for vibroacoustic and other ambient sensing, and other approaches including, for example, time-series current data.

In some embodiments, the systems and methods described herein utilize Contextual Activation, i.e. the ability for a mobile or wearable device to launch a diagnostics application in background when needed, just as it might instead load, for example, a fitness application when detecting motion indicative of running.

In some embodiments, the systems and methods may be implemented as an application or software on a mobile device. With the application launched, sensor samples may be recorded, e.g. from the microphone and accelerometer. These data may then be used to identify the vehicle and engine category, perhaps classifying these based entirely on the noise produced, or in concept with additional data sources, such as a connected vehicle's Bluetooth address, its user/company's vehicle management database and so on. In some embodiments, the systems and methods may be implemented as an application or software on a wearable device.

Once the vehicle and variant is identified, this information may be used to identify operating mode, and from this, a “personalized” algorithm may be selected for diagnostic or other activities.

In some embodiments, in aggregate the system may operate similar to a decision tree—by selecting the appropriate leaf corresponding to the vehicle make, variant, and operating status, it may be possible to select a similarly-specific prognostic or diagnostic algorithm or model tailored to the particular nuance of that system. In some embodiments, implemented carefully, the entire system may run seamlessly, such that the sensor sample may be captured, the context may be identified, and the user may be informed of issues worth her or his time, attention, and money to address. This seamlessness may key to the success of the described pervasive sensing concept—to maximize the utility of a diagnostic application, it must require minimal user interaction.

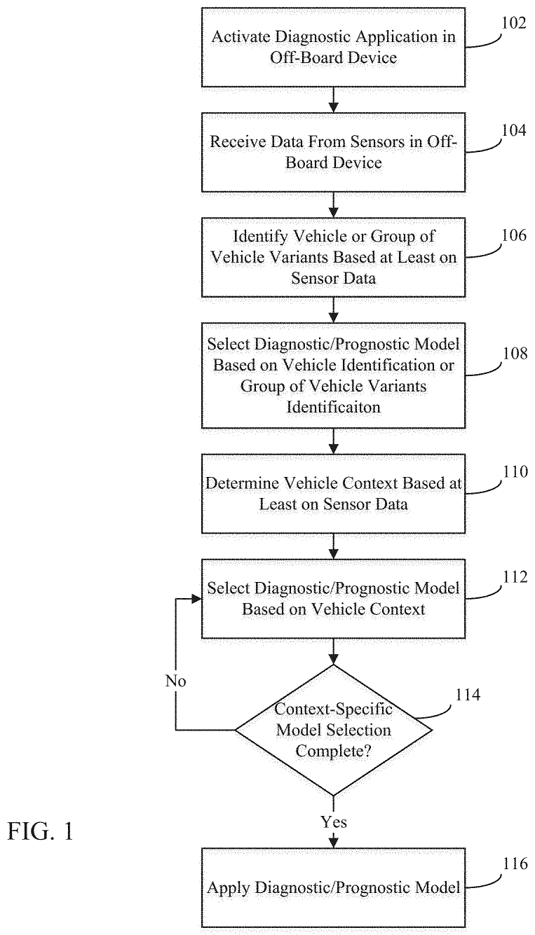

FIG. 1 illustrates a method for context-based diagnostic model selection in accordance with an embodiment. As mentioned above, while FIG. 1 will be discussed herein in reference to an application for vehicles, it should be understood that the method for context-based diagnostic model selection may be used in connection with diagnostics and condition monitoring of other types of systems and devices. At block 102, the diagnostic application in an off-board device (e.g., a mobile device such as a smartphone, a wearable device, etc.) may be activated. In some embodiments, the use of contextual activation may enable the application to operate data capture only when the off-board device is in or near a vehicle, and the vehicle is in the appropriate operating mode for the respective test (e.g. on, engine idling, in gear, or cruising at highway speeds on a straight road). This may allow the software (built as a dedicated application inside the off-board device), in some embodiments, to operate as a background task or to be launched automatically when the off-board device detects it is being used within an operating vehicle.

In some embodiments, implementations of the described automatic, context-based software execution may include automatic application launching when the phone is connected via Bluetooth to the car, or when a mapping or navigation application is opened. In the example of launching the application when a mapping or navigation application is opened, the GPS and accelerometer may be utilized to understand the specific kind of road the vehicle is running on, as well as its speed, e.g. to disallow certain algorithms such as those used to detect wheel imbalance from running on cracked or gravel roads.

At block 104, data from the monitored system, for example, a vehicle, may be received that was acquired or sampled by one or more sensors in the off-board device. For example, in some embodiments, acoustic and vibration data may be acquired using a microphone and an accelerometer, respectively. In some embodiments, the sensors in the off-board device may be other types of ambient sensing devices. The data may be provided directly from a sensor or may be retrieved from data storage or memory. As mentioned above, the use of contextual activation may enable the application to operate data capture only when the off-board system (e.g., a mobile device, a wearable device, etc.) is in or near a vehicle, and the vehicle is in the appropriate operating mode for the respective test (e.g. on, engine idling, in gear, or cruising at highway speeds on a straight road).

Some embodiments of the context-based diagnostic model selection system and method may comprise a “context layer” for generating characteristic features and/or uniquely-identifiable “fingerprints” for a particular system (e.g., a vehicle), which may then pass system-level metadata (system type, other details, and confidence in each assessment), along with raw data and/or fingerprints to a classification and/or gradation system. This “context layer” may be used both in system training and testing, such that recorded samples may exist alongside related metadata and therefore may allow for classification and gradation algorithms to improve over time, as increasing data volume generates richer training information even for hyper-specific and rare system configurations.

The described application may therefore capture raw signals and preprocess engineered features to be sent to a server (these fingerprints are space-efficient, easier to anonymize, more difficult to reverse, and repeatable), uploading these data at regular intervals or triggered upon a particular event.

At block 106, vehicle identification, or identification of a grouping of similar vehicle variants is performed. Depending on the system in the vehicle to be diagnosed, similarities may take place as a result of engine configuration, suspension geometry, and so on.

A vehicle “group” may be identified by, for example, engine type—that is, configuration, displacement, and other geometric and design factors. For example, an engine may be classified to be gasoline powered, with an inline configuration, having 4 cylinders with 2.0 liters of displacement, turbocharged aspiration, and manufactured by Ford.

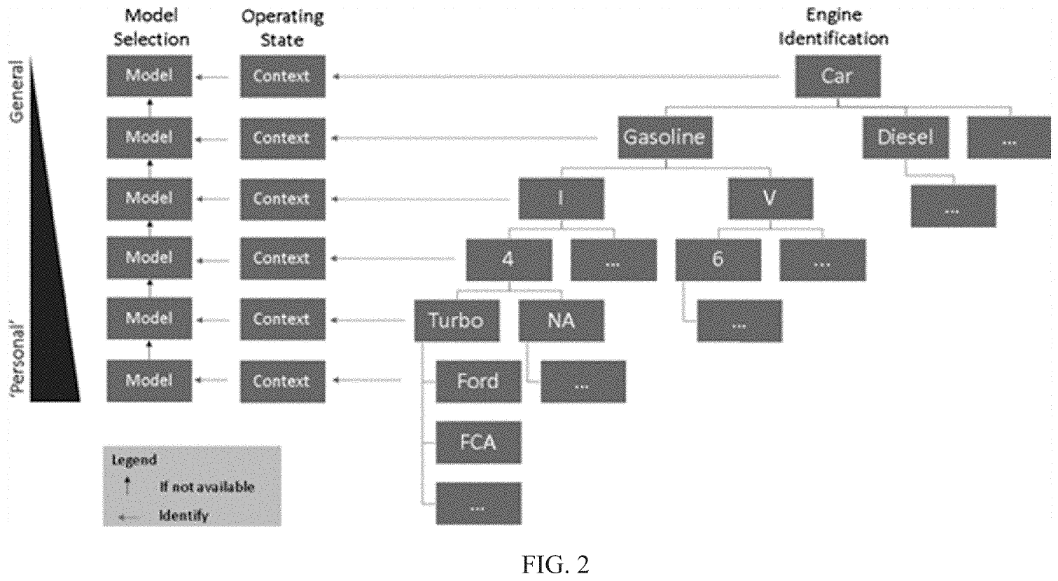

At block 108, a diagnostic or prognostic model (e.g., an instance-specific model) may be selected based on the vehicle identification or the identification of a group of vehicle variants. The selected model may be stored in, for example, a database of diagnostic models. The database may be stored on the off-board device or may be a remote database stored on a computer system or server in communication with the off-board device via a wired or wireless connection. If a database does not include any available diagnostic algorithm (e.g. a misfiring test) for the identified engine type, increasingly less-specific parent class models may then be looked at, such as generic car-maker-independent gasoline I4 2.0 turbo engine. If this is also not available, the process may go higher- and higher-level until it is necessary to use the least-specific model, in this case, a model trained for all gasoline engines—at the cost of potentially-decreased model performance. Alternatively, a similar engine may be considered for use, with slight difference in displacement or powered by LPG fuel. FIG. 2 illustrates a representative model selection process, indicating a means of identifying a vehicle variant and then selecting the most-specific diagnostic model available in order to improve predictive accuracy.

In some embodiments, by extending this process, it may become possible to identify a particular vehicle instance, particularly based on features learned over time (e.g. indicating wear).

Other subsystems, such as bodies and suspensions, may also be identified using the disclosed systems and methods. For example, identifying operating context and road condition may be used to identify when a car hits a pothole, with the post-impact oscillations indicating the spring rate, mass, and damping characteristics indicative of a particular vehicle make or model. As with engines, in some embodiments subtleties may be used to identify vehicle instances, e.g. damping due to tire inflation.

In some embodiments, if the vehicle is known to the off-board device user and “short list” of vehicles frequented by the user, this portion of the classification may be replaced by ground-truth information, or selection may be made among a smaller/constrained subset of plausible options. Moreover, if the application is activated based on the Bluetooth connection indicating proximity to a particular vehicle, it may be identified with near-certainty. In order to reduce the degree of user interaction required, this and other automation tools may be used to identify vehicles and operating context in order to run engine and other diagnostics as a sort of background process.

Once the vehicle is selected, at block 110 its context may be identified based on at least the sensor data. In some embodiments, context classification may use vibroacoustic cues (and vehicle data, if available) to identify the operating state of, for example, the engine, gearbox, and body. For example, is the engine on or off? If it is on, what is the engine RPM? Is the gearbox in park, neutral, or drive—or if a manual transmission, in what gear is the transmission, and what is the clutch state? In some embodiments, the context may include the system type, configuration, and instance identity in addition to the use case, operating mode, environmental factors, etc.

At block 112, a diagnostic or prognostic model (e.g., a context-specific model) may be selected based on the identified vehicle context from block 110. Some models or algorithms may be able to operate with minimal information related to vehicle context (e.g. diagnosing poor suspension damping may require the vehicle simply to be moving as determined by GPS, whereas measuring tire pressure may require knowing the car is in gear and headed straight to minimize the impact of noise and other artifacts on classification performance). In some embodiments, with context selection, a similar process may be used to that used for vehicle type and instance identification, namely, selecting the model with metadata best reflecting the instrumented system to ensure the best fit and performance.

In an example implementation, a decision tree may be created to identify the current vehicle state—with consideration given to engine operating status, gear engagement, motion state, and other parameters—and rather than using this tree to select a model for diagnostics, this tree may be pruned to suit a particular diagnostic application's needs (e.g. engine power might not matter for an interior NVH detection algorithm, or a tire pressure measurement algorithm may require the vehicle to be moving to function). The pruned tree may then be used to select the ideal algorithm or model with the most-specific match between the training data and the current operating context.

In some embodiments, with complicated vehicle operating contexts, and with systems measured under uncertainty, binary states may not be sufficient to describe the system status. For this reason, a three-state or higher system, e.g., comprising values of −1, 0, and 1, may be used in some embodiments.

In some embodiments, if a context parameter is 1, it is true or the condition is met. If it is 0, it is false, or the condition is not met. If an identified context parameter is a negative value (−1) that means it is unnecessary for the diagnostic application, not available, uncertain, or not applicable (e.g. lateral acceleration is not applicable if a vehicle is stationary).

In some embodiments, these negative values may be removed from the input feature vector, and the corresponding element class may also be removed from the reference database. In this way, a nearest neighbor matching algorithm may ignore uncertain or unnecessary data in considering the model to be used for diagnostics or prognostics. This matching algorithm may need a distance metric, which are algorithm-specific weighting coefficients used to define the importance of each context parameter (e.g. state of the engine may be more important than the amount of longitudinal acceleration when diagnosing motor mount condition, assuming both parameters are known).

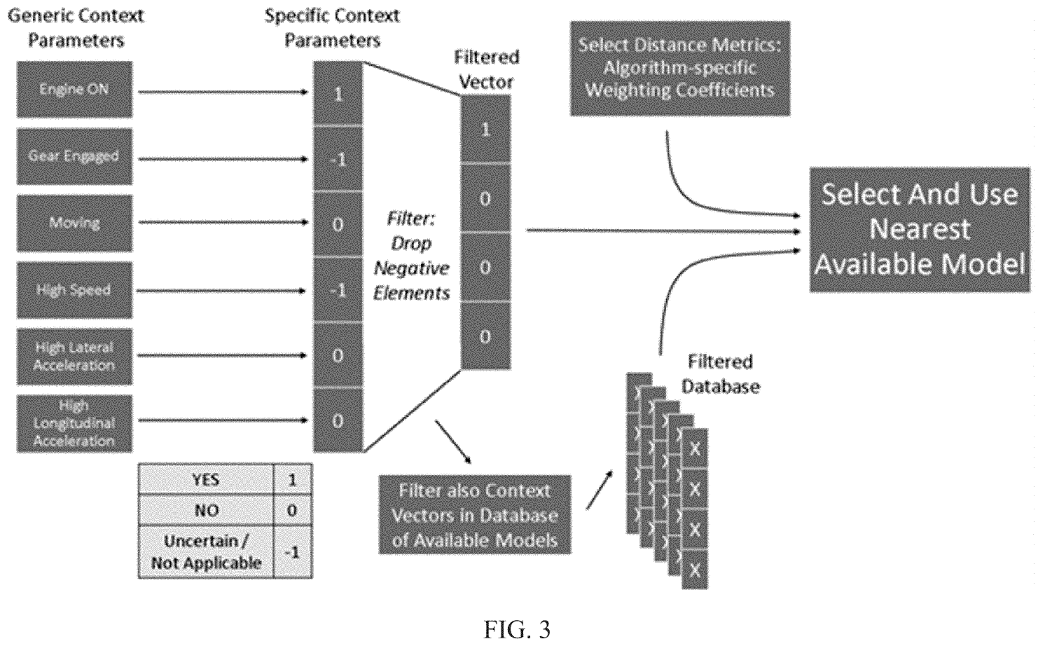

A visual overview of an example context identification and nearest-neighbor model selection process appears in FIG. 3 In some embodiments, the model selection process may rely on correct identification of both the vehicle variant and the context. FIG. 3 illustrates an example method for identifying the vehicle context and using those relevant features to select an appropriate “nearest neighbor” when identifying the optimal diagnostic or prognostic model to choose in accordance with an embodiment. Context parameters may be identified through distinct, binary classifiers capable of reporting confidence metrics. In this example, the context vector may comprise entries with three possible states (yes/no/uncertain or irrelevant), and those uncertain or irrelevant entries and their corresponding matches in the reference database may be removed such that only confident, relevant parameters are used to select the nearest trained model.

Just as Bluetooth connectivity may be used to limit the plausible set of vehicle types, in some embodiments so too may data from sources such as on-board diagnostic systems be used to limit the set of feasible operating contexts, thereby removing uncertainty from the model selection process.

By combining vehicle identification with context classification, comprehensive vehicle “metadata” may be identified in some embodiments — for example, “light duty, 2.0 liter, turbocharged, Ford, Mustang, Joe's Mustang.” With the fullest possible context identified, a list of feasible diagnostic algorithms may then be shortlisted.

Certain diagnostics may be feasible for each set of vehicle classes and operating contexts. For example, if a vehicle is moving, only algorithms working for moving vehicles will be available. In another example, if a vehicle is at idle, only algorithms operating at engine idle will be available. In another example, if a vehicle is on a gravel road, only algorithms suitable for rough terrain will be offered.

When the off-board device identifies an appropriate context and short-lists feasible diagnostic algorithms, the most-specific diagnostic model of that type available with sufficient n of training vehicles may be chosen and run on the raw data or engineered features provided by the off-board device (and vehicle sensors, if available).

In some embodiments, these algorithms may initially start out coarse—is the engine normal or abnormal? Are the brakes normal or abnormal? In some embodiments, over time, as algorithms become more sensitive, and as training data are generated (with labeled or semi-supervised approaches), more classes may be added. In some embodiments, the disclosed system and method may transition from binary classification (good/bad), to gradation (80% remaining life, 10% worn), to diagnostics so sensitive that they in fact are prognostics—that is, algorithms sensitive enough that faults may be detected and addressed proactively.

The result may be improved efficiency, reliability, performance, and safety, and eased management of large-scale, high-utilization fleets, such as those that will be run by shared mobility services. In some embodiments, the algorithms or models used may over time be adapted to minimize a cost function, e.g. balancing user experience with maintenance cost with the likelihood of having a car break down on the road. This may supplant data-blind proactive scheduled maintenance with data-driven insights sensitive to use environment, risk tolerance and mission-criticality.

At block 114, it may be determined whether the context-specific model selection is complete. If the context-specific model selection is not complete, for example, there are additional features of the vehicle context to be analyzed to identify a diagnostic model, the process returns to block 112. For example, based on the example given above, a model may be chosen based on the context off whether the engine is on or off. Once it is determined whether the engine is on or off, a model may be selected based on whether, for example if it is on, the engine RPM. In some embodiments, the context determination and model selection process may be performed sequentially. In some embodiments, the context determination and model selection process may be performed at the same time. In some embodiments, when the context determination and model selectin are done sequentially, each step the section or prediction may be based on all previous and subsequent features. At block 114, if the context-specific model-selectin is complete, the selected diagnostic or prognostic model may be applied at block 116. In some embodiments, the results of the application of the selected model(s) may be stored in, for example, data storage or memory of the off-board device. In some embodiments, the results of the application of the selected model(s) may be sued to generate a report or alert that may be provided to a user. For example, a report may be provided on a periodic basis or may be provided when an issue or problem is identified.

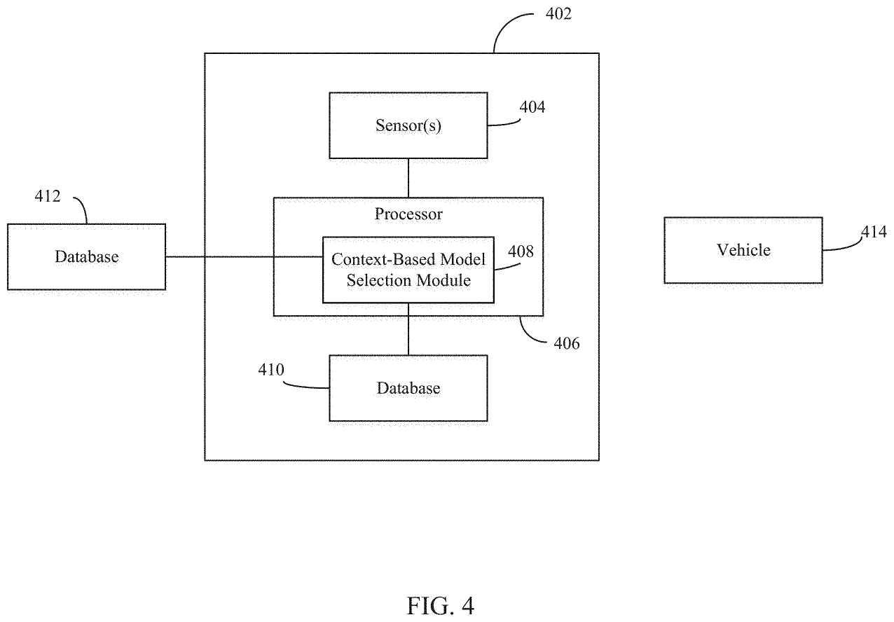

FIG. 4 is a block diagram of an example system for off-board diagnostics using a method for context-based diagnostic model selection in accordance with an embodiment. The illustrated embodiment in FIG. 4 is directed to an off-board device 402 (e.g., a mobile device, a wearable device, etc.) configured for diagnostic and condition monitoring using context-based diagnostic model selection for a vehicle 414. The off-board device 402, for example a smartphone, may include sensor(s) 404 and a processor 406 coupled to and in signal communication with the sensor(s) 404. The processor 406 may include a context-based diagnostic model selection module 408. The off-board device 402 may also include a database 410 that may be used to store a plurality of instance-specific models and context-specific models. The off-board device 402 may also be in signal communication (e.g., via a wired or wireless communication link) with an external database 412 that may also be used to store a plurality of instance-specific models and context-specific models. The external or remote database may be stored on, for example, another computer system or server. In some embodiments, models that are accessed more frequently by the processor 406 may be stored in the database 410 on the off-board device and models that are access less frequently by the processor 406 may be stored in the external database 412 and accessed and retrieved by the processor 406 when needed. In some embodiments, the sensor(s) may include vibroacoustic sensors, such as a microphone and an accelerometer, or other ambient sensing devices. In some embodiments, the off-board device 402 may also be in wireless communication with the vehicle 414 (e.g., via a Bluetooth connection) to access data directly from the vehicle 414.

Embodiments of example classification systems that may be used to identify critical vehicle powertrain parameters useful for automated model selection through the creation of a flexible and user-friendly framework for testing varied featured generation and classification approaches is described further in Appendix A attached hereto. In the description in Appendix A, feature extraction, machine learning, software framework, and results are presented for three different label categories: engine aspiration, fuel type, and cylinder count. These labels may be predicted sequentially in order to exploit potential correlation, leading to a ROC-AUC higher than 93% for the measured parameters in many cases.

In the various embodiments and examples described in Appendix A, samples of varied engines were recorded from known examples from, for example, workshops, and from video clips of idling vehicles. Samples were captured variously from underhood, near a closed hood, and near the vehicle's exhaust. In these examples, data were manually labeled and in the case of uncertainty, labels were not assigned. Class balance was impacted by limited data availability, particularly reflecting a small number of “Vee” engines and low cylinder-count engines, though trends broadly reflected the imbalanced nature of real-world powertrain diversity.

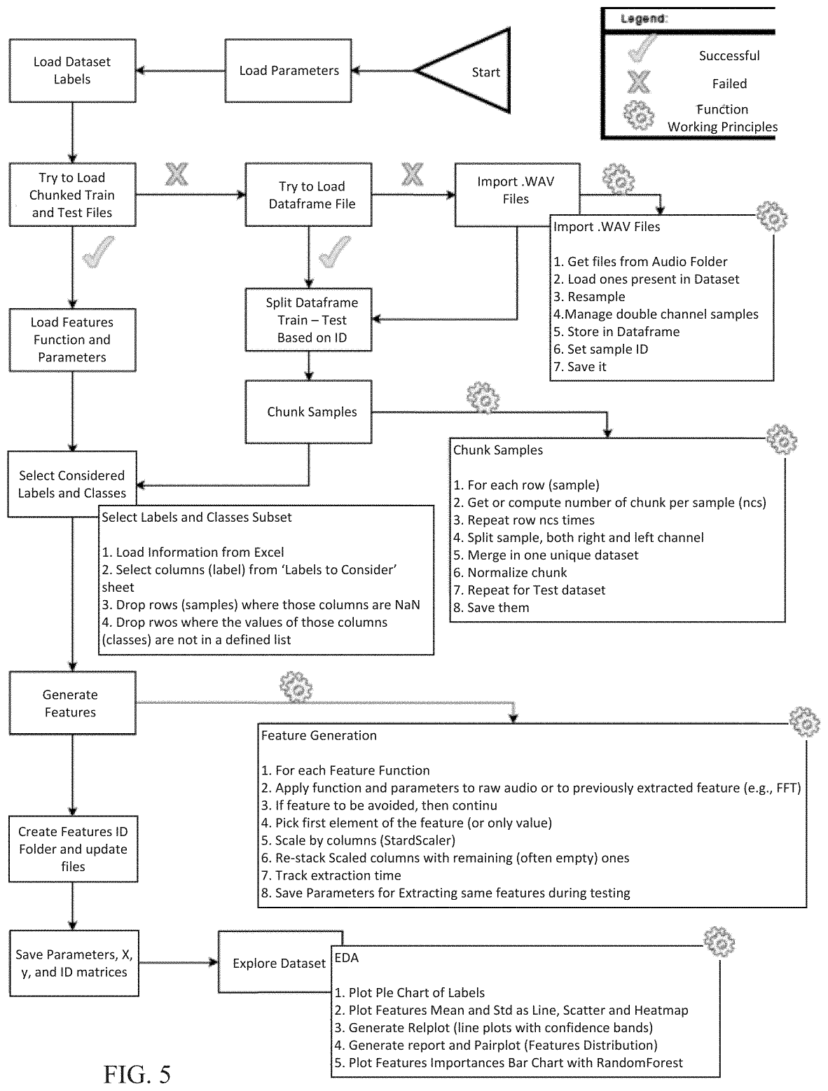

In some embodiments, a Python clip randomizer and feature extraction framework was developed to provide input into diverse classification models. A framework was created to support the generation of similar features including Fourier Coefficients, Mel-Frequency Cepstral Coefficients, and Discrete Wavelet Transform (DWT) features. These parameters may capture critical waveform details that might be discernible to the human ear. In addition to these features, additional data such as skewness, kurtosis, power spectral density, and zero-crossing may also be included to provide additional differentiating power. For each feature, the example framework allowed for rapid configuration of feature parameters to aid in conducting a comprehensive grid search to find the globally-optimal model. In the examples described in Appendix A, based on the results from exploratory data analysis, hypotheses were identified for testing within various classifiers. An example data split and feature generation approach is shown in FIG. 5. FIG. 5 illustrates an example process by which captured engine audio is split into a set of informative features, as well as exploratory data analysis used to inform classifier design in accordance with an embodiment.

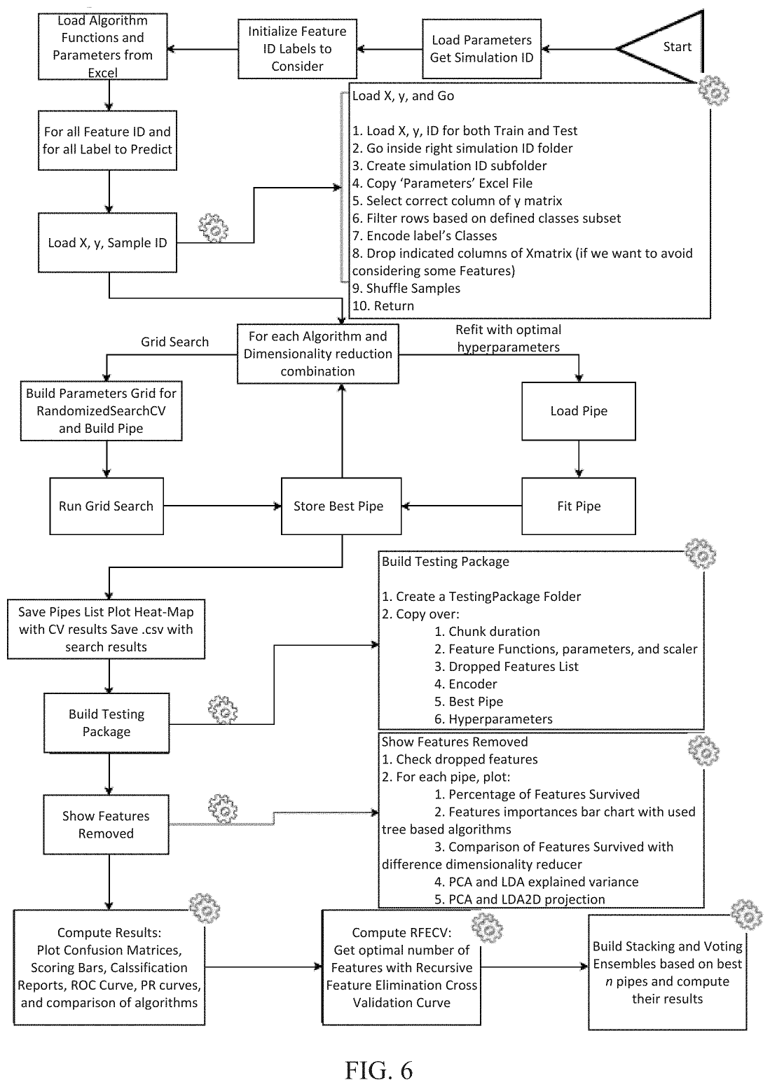

From the generated features, the embodiments described in Appendix A implemented software to conduct a grid search over classifier models and hyperparameters, the flow of which is shown in FIG. 6. FIG. 6 illustrates an example process through which feature sets are loaded in order to test varied classification models in accordance with an embodiment.

In the embodiments described in Appendix A, the first several context layers may be assumed—in this case, that the system is a light-duty vehicle, that and that it is idling. Aspiration type, fuel, and cylinder count my then be classified as a means of working towards increasingly-specific diagnostic model selection. The ordering of this embodiment varies slightly to that described above with respect to FIGS. 1-3 and was determined based on apparent correlation among the sample dataset; in some embodiments, the optimal ordering may be determined based on the available input data.

From an exhaustive search described in Appendix A, satisfactory performance for aspiration classification may be found using an ExtraTrees classifier with Random Forest as a feature dimensionality reducer with the Receiver Operating Characteristic (ROC) Area Under the Curve (ROC-AUC)=0.82 and the Precision-Recall Area Under the Curve (PR-AUC)=0.8, with the confusion matrix in Table 1. In the examples described in Appendix A, the classification result was dominated by Fast Fourier Transform (FFT) features, with some informative Mel-Frequency Cepstrum Coefficient (MFCC) features.

TABLE 1
This Confusion Matrix shows the results for the aspiration-type
classifier described in Appendix A, which used an ExtraTrees
classifier with Random Forest as a feature dimensionality reducer
to classify based primarily upon FFT and MFCC features.

| | Normally Aspirated | Turbocharged |
|---|---|---|
| Normally Aspirated | 0.72 | 0.09 |
| Turbocharged | 0.28 | 0.91 |

Similarly, in some embodiments a fuel type classifier may be developed using a grid search approach. In this example, aspiration status may be used as an additional feature in determining fuel type. In this example, Gradient Boosting is the most-effective classifier, using FFT meta-statistics as input. In this example described in Appendix A, attained ROC-AUC (0.99) and PR-AUC (0.994), with the confusion matrix shown in Table 2. Note that these results are for a single audio segment; if multiple segments are averaged and used to vote on the final classification; results improve further.

TABLE 2
This Confusion Matrix show s the results for the example fuel
classifier described in Appendix A, which used Gradient Boosting
to classify primarily based on FFT meta-statistic features.

| | Diesel | Gasoline |
|---|---|---|
| Diesel | 0.93 | 0.05 |
| Gasoline | 0.07 | 0.95 |

Cylinder count maybe considered as the next and most-specific level of context for use in model selection within the framework embodiment described in Appendix A. This level of context classification may entail multi-class labels, and may suffer from class imbalance. While region-specific models may improve performance by excluding uncommon labels, broader models struggle to attain satisfactory performance.

In the worst-case model, in which all available labels are represented, the embodiment of the described in Appendix A found that using gradient boosting as a feature reducer and XGBoost as a classifier yielded the best performance, with a ROC-AUC=0.93 and PR-AUC=0.856. The confusion matrix appears in Table 3.

TABLE 3
This Confusion Matrix shows the results for the worst-
performing, broadest cylinder count classifier.

| | 3 | 4 | 6 | 8 |
|---|---|---|---|---|
| | Cylinder | Cylinder | Cylinder | Cylinder |
| 3 Cylinder | 0.5 | 0.0072 | 0.24 | 0 |
| 4 Cylinder | 0 | 0.82 | 0.5 | 0.33 |
| 6 Cylinder | 0.5 | 0.072 | 0.12 | 0 |
| 8 Cylinder | 0 | 0.099 | 0.14 | 0.67 |

Based on the strong per-parameter classification results for these three contextual classifiers described in Appendix A, it is clear to see the feasibility in developing a suite of algorithms for determining a vehicle's use and operating context and how such data may be used as features in selecting an appropriate diagnostic model, whether for condition monitoring, or fault detection or analysis. With such a framework in place, it becomes feasible to select specific or generalized diagnostic algorithms based on the confidence of contextual classification and the availability of variously-tailored diagnostics.

In some embodiments, context-specific models tailored to a single engine variant may demonstrate enhanced performance over a 15-vehicle trained generalized on the order of approximately 10%, and better than a model trained on six vehicles with the similar engine configuration by approximately 5%.

In some embodiments, the data used were from varied, uncalibrated devices. While calibration may be necessary in some embodiments to attain quantitative, rather than qualitative, results, it may not be necessary in some embodiments when using appropriately pre-processed data to differentiate among vehicle configurations.

The systems and methods described herein paint a bold picture for the future related to transitioning on-board diagnostic systems into off-board, consumer-owned devices with the potential to upgrade both software and hardware over time. In addition, the systems and methods described herein may be designed to revolutionize automotive diagnostics and maintenance, particularly, for example, for ride-share companies already reliant upon mobile applications for driver accessibility and vehicle tracking.

As part of a mobile application, in some embodiment customers may report data about vehicle health back to the fleet manager, and their phone may be used to collect data and to pay for the bandwidth of the logger. Beyond mobile devices, vibroacoustic diagnostics may be built into, for example, garage door openers, service stations, or parking lots.

In some embodiments, the disclosed systems and methods for context-based model selection may utilize diagnostic results in conjunction with emerging technologies such as augmented and virtual reality and 3D printing to guide component inspection, maintenance, production, and replacement, with AR helping walk untrained users through component inspection, testing, and replacement, even guiding them through validating diagnoses. The same mobile devices used for diagnostics may then be used to access Augmented and Virtual Reality visualizations of components and their wear states or fault conditions. Connected vehicle services may be used to automate repair and maintenance scheduling, to minimize downtime for shared fleets.

While the present disclosure describes embodiments and examples in the automotive field, the systems and method for context-based diagnostic model selection may also be used in other technological fields. For example, the concept of pervasive sensing diagnostics (e.g., using vibroacoustics, time series current data, etc.) may extend more broadly into “universal diagnostics,” wherein the same techniques discussed herein may be used for ubiquitous sensing of other device and system types and classes. For example, appliances including washing machines and microwaves may be monitored as well as cars, trucks, motorcycles, and bicycles.

The present disclosure describes a multi-step framework to pick hyper-specialized models based on device type and use context. In some embodiments, vibroacoustic analysis may be applied across the automotive life-cycle, from monitoring production equipment to measuring process outputs to estimating (and automatically improving) the condition of automotive subsystems.

In some embodiments, vibroacoustic signals may be used to diagnose faults in other electromechanical systems, such as power tools and coffee grinders. In some embodiments, similar techniques may help instrument people, diagnosing, for example, early-onset Parkinson's disease.

Combining pervasive sensing with enhanced diagnostics and embodied intelligence—that is, the ability for an application to bring expert knowledge to non-expert users—has the potential to change the world well beyond computer science, revolutionizing mechanical, chemical, and electric engineering, materials, science, and beyond.

In additional embodiments contemplated hereunder, two alternative approaches for achieving vibroacoustic assessment of an engine are provided which utilize deep learning. One approach can be thought of as implementing a ‘Cascading’ classification approach via one or more deep learning networks, wherein the output of one network is utilized as an input to another network. The other approach can be thought of as implementing a ‘Parallel’ classification approach via a single deep learning network. Though, as described below, this could in practice be implemented in several ways that accomplish the same general construction.

### Cascading Deep Learning Implementation

In Cascading embodiments for vibroaccoustic vehicle diagnostics, the processes for classifying and characterizing an engine initially described above can be modified such that a novel cascading architecture can be implemented. For example, in some embodiments a cascading architecture may be implemented as a multi-level, sequential, conditional neural network that makes multiple predictions and cascades each prediction to one or more successive layers of the network. Such a network can integrate multiple highly-granular classification tasks such that the output of each task may inform successive tasks. In other words, a Cascading architecture can be thought of as a multi-level, sequential, conditional network that makes multiple predictions and cascades some or all of such predictions to successive layers of the network.

Embodiments of Cascading architectures (as will be described below further) can focus on multiple low-level, fine-grained multi-level label predictions with the assumption of the highest-level class, rather than simply classifying a single level at a time. Given the Cascading approach can focus on these fine-grained tasks, the approach does not need to utilize general acoustic embeddings but rather lightweight models trained from scratch. Additionally, the Cascading approach can be implemented so as to utilize data collected at a higher sampling rate (48 kHz) compared to that collected from public sources (such as YouTube, which sources can cap sampling rate and in the process may discard useful informative features that may have provided useful insights in training). Thus, models trained on publicly available audio sample repositories (e.g., crowd-sourced audio from phones in vehicles) may not perform as well as models trained and operated using raw, full-frequency audio directly collected from a mobile device. Publicly-available sources also conduct feature-destructive compression on some audio samples, which can limit model performance and generalizability. Thus, the approaches described herein use larger frequency ranges to provide detailed classification lower into the stack.

In one experiment performed by the inventors, a system was implemented using a cascading architecture constructed as a two-stage convolutional neural network (CNN) with a first stage specializing in vehicle attributes which cascaded its attribute predictions to a second stage which classified input signals as having a specific fault condition (e.g., misfire fault). The following disclosure will describe such a system in detail, then expand upon how such a system could be modified (e.g., to have different, more, or fewer input types; to detect more types of fault conditions or other such conditions of an engine; to be deployed via different hardware implementation; etc.).

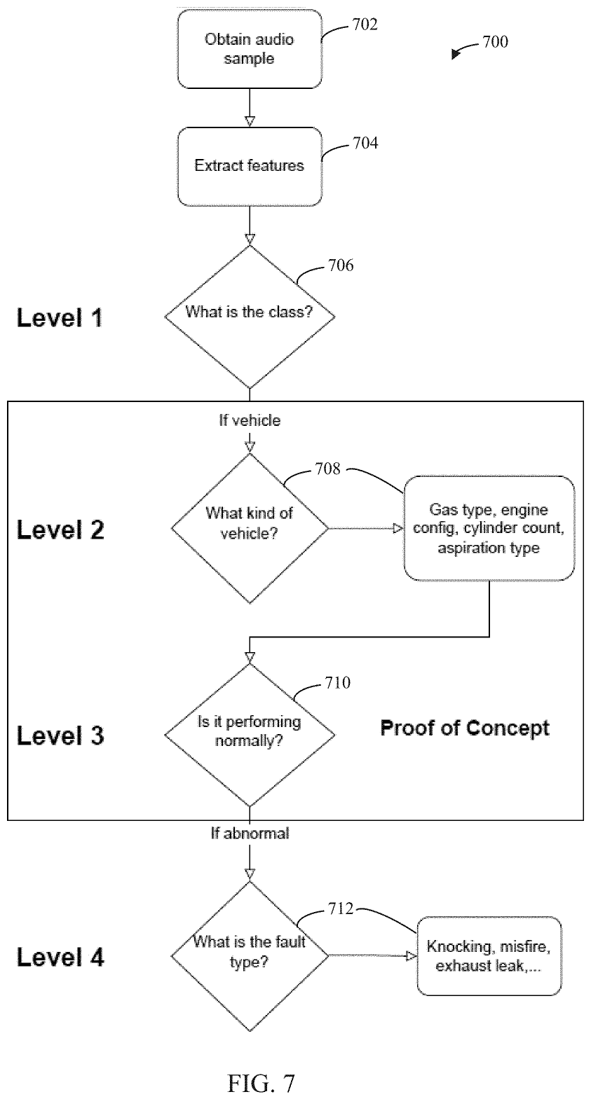

Referring now to FIG. 7, a conceptual flowchart illustrating how a cascading network could perform is shown. In some examples, the process 700 may be carried out by an on-board or off-board device 402 illustrated in FIG. 4. However, it should be understood that the process 700 may be carried out by any suitable apparatus or means for carrying out the functions or algorithm described below. Additionally, although the steps of the flowchart 700 are presented in a sequential manner, in some examples, one or more of the steps may be performed in a different order than presented, in parallel with another step, or bypassed.

The Cascading network integrates multiple highly-granular classification tasks, and the result of each successive classification task can be used the next classification task. Here, the Cascading network can have four distinct layers: 1) general acoustic classification (does the audio sample contain a vehicle), 2) attribute recognition (what is the kind of vehicle?), 3) status prediction (is the vehicle performing normally), and 4) fault identification (if abnormal, what fault is occurring?). The Cascading network can complete these tasks simultaneously in a unified deep neural network architecture. The Cascading network architecture can use multi-level, sequential, and conditional networks as shown in FIG. 7.

At step 702, audio samples can be obtained. For example, the audio samples can include raw samples (e.g., a waveform). In some examples, the audio samples can be obtained using off-board devices (e.g., mobile phones or any suitable device to record sound from a vehicle). For example, the mobile phone microphone can record audio samples, which tend to have repeatable characteristics within the range of frequency similar to those of human speech and hearing (roughly 20 Hz-20 kHz). However, it should be appreciated that the microphone is not limited to the microphone in the mobile devices. For example, the microphone can be any suitable condenser (e.g., DC-biased condenser, RF condenser, electret condenser, valve microphone, dynamic microphone, piezo microphone, etc.) to record sound from the vehicle. It should be understood that the audio sample can be obtained using on-board devices with capability to record sound occurring in the vehicle. In further examples, the audio samples can be split into pre-determined second clips (e.g., 1, 1.5, 2, 2.4, 3, or any other suitable time-length clips). However, it should be appreciated that the audio samples can be dynamically split into clips with various time length. The pre-determined second can be any suitable seconds to provide features and models with a standard input size for training and be short enough that would allow for clips within the same sample to be distinct and useful for training. In even further examples, the audio samples can be augmented for training the Cascading neural networks based on different augmentation parameters (e.g., change volume between −5.0 and 5.0, pitch shift between −0.25 and 0.25, change speed between 0.92 and 1.08, and background noise addition with signal to noise ration (SNR) between 0.05 and 0.20, etc.). In a non-limiting scenario, the audio samples can utilize a 48 kHz sampling rate, for which frequencies ≤24 kHz are considered according to the Nyquist-Shannon Sampling Theorem. These samples were collected using a stereo microphone for which the dual channel input is averaged into a single mono channel. Each sample was split into 3 second chunks which results in a 1×72; 000 input vector for the raw waveform.

At step 704, audio features can be extracted from the audio sample. In some examples, an audio feature can include the raw sample (e.g., vibroacoustic data) itself. The waveform may include time domain information. In other examples, the audio feature may can include Fast Fourier Transform (FFT), which transform the waveform from the time domain to the frequency domain. Thus, the FFT can provide the model with frequency information. In further examples, the audio feature can include Mel-frequency Cepstral Coefficients (MFCCs), spectrograms, or wavelets. MFCCs, spectrograms, and wavelets can provide the model with varying degrees of hybrid time and frequency information at different dimensionality. For example, the FFT, waveform, and wavelets can include 1D information, while spectrogram and MFCCs can include 2D information. It should be appreciated that the audio feature can include any other suitable feature extracted from an audio sample.

At step 706, whether a vehicle is contained in the extracted audio feature can be identified. In some examples, the vehicle can include a road vehicle (e.g., car) However, it should be appreciated that the vehicle can include any other suitable vehicles (e.g., water, road, rail, and air vehicles).

In some examples, steps 708 and 710 can be implemented using a two-stage neural network. An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network. Here, the first stage receives one or more of the previously described feature sets at step 704 as input while the second stage receives both the feature set and the attribute predictions from the first stage.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs. In an example in which the first stage of the two-stage artificial neural network, the output layer may include, for example, a number of different attributes, where each different node in each attribute corresponds to a different attribute prediction. In a non-limiting example, the output of the first stage of the two-stage artificial neural network can include four attributes (e.g., fuel type, engine configuration, cylinder count, and aspiration type). The fuel type attribute can include two nodes indicative of gasoline and diesel, respectively. The engine configuration attribute can include three nodes indicative of flat configuration, inline configuration, and Vee configuration, respectively. The cylinder count attribute six nodes indicative of 2, 3, 4, 5, 6, and 8, respectively. The aspiration type attribute can include two nodes indicative of normal aspiration and turbocharge aspiration, respectively. It should be appreciated that the types of attributes and the nodes in each attribute are mere examples and can be any other suitable attributes and nodes. In further examples, the output of the second stage of the two-stage artificial neural network may include, for example, a number of different nodes, where each different node corresponds to a different fault. For example, there could be two nodes indicative of a normal state and an abnormal state. In other examples, the nodes can include types of abnormal state (e.g., knocking, misfire, exhaust leaks, or any other faults).

During training, the artificial neural network receives the inputs (e.g., audio samples, features, etc.) for a training example and generates an output using the bias for each node, and the connections between each node and the corresponding weights. The artificial neural network then compares the generated output (e.g., predicted attributes of the first stage of the two-stage neural network, and fault detection of the second stage of the two-stage neural network) with the actual output of the training example. Based on the generated output and the actual output of the training example, the neural network changes the weights associated with each node connection. In some embodiments, the neural network also changes the weights associated with each node during training. The training continues until a training condition is met. The training condition may correspond to, for example, a predetermined number of training examples being used, a minimum accuracy threshold being reached during training and validation, a predetermined number of validation iterations being completed, and the like. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

Different types of artificial neural networks can have different network architectures (e.g., number of layers, type of layers, ordering of layers, connections between layers, hyperparameters for layers). In some configurations, neural networks can be structured as a single-layer perceptron network, in which a single layer of output nodes is used and inputs are fed directly to the outputs by a series of weights. In other configurations, neural networks can be structured as multilayer perceptron networks, in which the inputs are fed to one or more hidden layers before connecting to the output layer.

As one example, an artificial neural network can be configured as a feedforward network, in which the connections between nodes do not form any loops in the network. As another example, an artificial neural network can be configured as a recurrent neural network (“RNN”), in which connections between nodes are configured to allow for previous outputs to be used as inputs while having one or more hidden states, which in some instances may be referred to as a memory of the RNN. RNNs are advantageous for processing time-series or sequential data. Examples of RNNs include long-short term memory (“LSTM”) networks, networks based on or using gated recurrent units (“GRUs”), or the like.

Artificial neural networks can be structured with different connections between layers. In some instances, the layers are fully connected, in which each all of the inputs in one layer are connected to each of the outputs of the previous layer. Additionally or alternatively, neural networks can be structured with trimmed connectivity between some or all layers, such as by using skip connections, dropouts, or the like. In skip connections, the output from one layer jumps forward two or more layers in addition to, or in lieu of, being input to the next layer in the network. An example class of neural networks that implement skip connections are residual neural networks, such as ResNet. In a dropout layer, nodes are randomly dropped out (e.g., by not passing their output on to the next layer) according to a predetermined dropout rate.

In some embodiments, an artificial neural network can be configured as a convolutional neural network (“CNN”), in which the network architecture includes one or more convolutional layers. For example, the two-stage neural network can include two distinct multi-layer convolutional neural network (CNN). While the first stage shown at step 708 predicts one or more attributes of the vehicle, the second stage at step 710 can detect a fault (e.g., misfire) based on the cascaded attribute predictions. In an experiment, the Cascading model achieved 95.6%, 93.7%, 94.0%, and 92.8% validation accuracy on attributes (fuel type, engine configuration, cylinder count, aspiration type, respectively). The Cascading CNN also achieved 93.6% misfire fault validation accuracy. In some examples, audio features can be grouped into 1D (FFT, waveform, wavelets) and 2D (spectrogram, MFCCs) sets, with two distinct model architectures that utilize 1D and 2D convolution, respectively. In further examples, the M5 architecture can be built for general audio classification using the raw waveform. General audio classification seeks to understand the high-level class of an acoustic sample such as speech, music, animal, vehicle, etc. This is a challenging task since general audio classification classes can range from tens to hundreds of distinct and unique labels. The unique aspect of the M5 model utilizes a large convolutional kernel size of 80 in the first layer to propagate a large receptive field through the network. In some examples, the kernel size of 3 can be used for the remaining three convolutional layers.

For the MFCC model, the inventors utilize kernel size of 2×2 since 13 MFCC coefficients were chosen as a hyperparameter which results in an input dimensionality of 130×13. For the spectrogram, we choose hyperparameters of 512 for hop length and 2048 for window size. This results in an input dimensionality of 1025×282. Since it was a larger input dimension than the MFCCs, traditional 3×3 kernels can be used for spectrogram.

For the 2D models, the two-stage neural network consists of three convolution layers, rather than four layers for the 1D models because of their smaller input width. In some examples, the precedent set can be followed, including pooling, batchnorm, and ReLU after each cony layer in 365 both 1D and 2D models. Also, dropout can be added with probability=0.5 after each layer to improve generalizability and to minimize the likelihood of overfitting. Each prediction task can be treated as classification and therefore final fully connected output layers can be obtained with dimensionality corresponding to the number of classes for each task. These predictions are then fed into log softmax and trained using negative log-likelihood loss.

At step 708 as the first stage of the neural network described above, one or more attributes of the vehicle can be determined based on the audio feature. For example, the one or more attributes can include, but is not limited to, fuel type (e.g., gasoline or diesel), engine configuration (e.g., flag, inline, or V), cylinder count (4, 6, 8), or engine aspiration. However, it should be appreciated that the one or more attributes are not limited to the list above. For example, the one or more attributes can further include engine state (accelerating, idling, starting), make/model/OEM, horsepower, etc. In some examples, the attributes can be recognized based on the periodic acoustic emissions of rotating assemblies in the vehicle.

At step 710 as the second stage of the neural network described above, based on the extracted audio feature and the attributes, a status of the vehicle can be predicted. For example, whether the vehicle performs normally can be predicted.

At step 712 as the second stage of the neural network described above, the abnormal status (e.g., knocking, misfire, exhaust leaks, etc) can be detected if the vehicle status is abnormal.

### Parallel Deep Learning Architecture

In Parallel embodiments, steps 802, 804, and 806 are substantially the same as steps 702, 704, and 706 in connection with FIG. 7, respectively.

Steps 808, 810, and 812 are also similar to steps 708, 710, and 712, in connection with FIG. 7, respectively. Unlike the Cascading model, the Parallel model combines steps 808 and 810 in parallel. Thus, extracted features in step 806 can be inputs to the Parallel network (e.g., CNN), and the Parallel network uses a shared representation for both the attributes and state predictions.

While the Cascading model can include a two-stage CNN, the Parallel model can include a single stage CNN. Both models can perform the same prediction tasks: attribute recognition and status prediction. Additionally, both models can use the same M5 backbone CNN architecture. This architecture include 3-4 convolutional layers, each of which is followed by ReLU activation, batch normalization, max pooling, and dropout. The convolutional kernel type and size may vary based on the input feature. For 1D features FFT, wavelets, and the raw waveform, 1D convolution can be used throughout with a kernel size of 80 in layer 1 followed by 3×3 kernels in the remaining layers. For 2D features MFCC and spectrogram, 2D convolution can be utilized. For the smaller dimension MFCC features, 2×2 kernels can be used for 3 convolutional layers. For the larger dimension spectrogram features, 3×3 kernels can be used for 4 convolutional layers. One difference between the Cascading and Parallel models includes the location of the fully connected output layers. For example, for the Cascading model, the attributes output layer can be at the end of the stage one CNN and the misfire output layer can be at the end of stage two CNN. Additionally, the input to the second stage CNN can include the predicted attributes and original input concatenated. For the Parallel model, since there is only one stage, both the attributes and misfire output layers can be at the end of stage one. There is novelty in both models in that the Cascading model showcases whether two stages are desirable where each stage can specialize on the attributes and misfire tasks, respectively. Additionally, the Cascading model can show the value of fusing the input features with additional “noisy” data (i.e., predicted attributes) for the second stage CNN focused on misfire. The Parallel model demonstrating a single stage and shared representation can achieve similar performance on attribute recognition while utilizing fewer overall parameters.

### Audio Sample Processing for Diagnostics

While several sensing modalities can be utilized for diagnostics, sound is an efficient, easy-to-use, and cost-effective means of capturing informative mechanical data, e.g. by using audio captured with a smartphone or other audio or vibration capturing sensor, to identify fault or wear states. In some embodiments, audio and vibration data may be captured using a microphone, in other embodiments this data may be captured using a motion sensor, such as an accelerometer, and in further embodiments, vibration and (indications of) audio may be captured via video capture. In the embodiments described above, sound data was captured using microphones.

Compared with images, video, and other high-volume information, sound, like acceleration, is densely informative and compact. As a result, sound can be efficiently processed in near real-time by low-cost hardware such as embedded devices. Audio is particularly useful for providing insight into systems with periodic acoustic emissions, such as the rotating assemblies commonly found in vehicles and other heavy and industrial equipment. These data enable the identification and characterization of system attributes as well as fault diagnosis and preventive maintenance. This problem, however, is non-trivial and presents unique engineering challenges.

When characterizing an audio signal, the first feature explored is the raw sample itself, known as a waveform. This waveform provides standalone insights, though research has shown that feature extraction and transformation is a crucial step in building successful models in some acoustic recognition tasks. Transforming the raw waveform from the time domain to the frequency domain with the Fast Fourier Transform (FFT) provides particularly informative features. Other informative feature types utilize hybrid time and frequency information, such as Mel-Frequency Cepstral Coefficients (MFCCs), spectrograms, and wavelets. This characteristic similarly makes algorithmic differentiation an easier task.

As noted above, raw audio (rather than compressed or other lossy audio from public repositories) in a wide frequency range is utilized for increased accuracy in some embodiments. However, large numbers of samples (for training, validation, testing, re-tuning, etc.) are not always widely available for any given combination of vehicle/engine/cylinder/aspiration type/tires/etc. Therefore, in some embodiments the inventors have utilized a data pre-processing and augmentation method on available raw audio (wide frequency, more data-rich) samples to increase the amount of data available to develop the Cascading and Parallel approaches described above.

First, samples of raw audio are acquired and labeled (e.g., by vehicle make/model/year, engine type, engine cylinders, transmission type, aspiration type, size/type of tires, etc.). This may be done by use of mobile devices or other sensors in vehicles. For example, in some embodiments a vehicle manufacturer may acquire audio of vehicle types at manufacturing time (presumably when no or few fault conditions might exist) and may utilize a network of dealerships and mechanics to record audio of vehicles with fault issues. In other embodiments, vehicles may have on-board sensors which record acoustic data, that can be labeled according to vehicle VIN number and fault codes determined at service visits. In yet other embodiments, vehicle owners may contribute audio recordings acquired from mobile device applications on a voluntary basis.

The audio samples may then be split into uniform clip size and organized by label, so as to provide more homogenous input to the neural networks. In one embodiment, the inventors split raw audio recordings into 3 second chunks, though other durations of clips are contemplated such as 1 second, 5 seconds, ten seconds, thirty seconds, etc.

Next, some or all of the audio clips may undergo an augmentation process. This may include such techniques as pitch shift, volume shift, speed change, and addition of background information. In some embodiments, a system may be employed that manages data distribution by label classification: in other words, audio samples of comparatively rare combinations of attributions (e.g., a rare fault condition, in a diesel engine or other less common engine) can undergo data augmentation (or more data augmentation) than samples of comparatively common combinations of attributes. In other embodiments, all data samples can undergo data augmentation. The degree of certain types of data augmentation may be set to correspond with limits or expected values associated with each vehicle type. For example, augmentation parameters can be set so as to line up with typical variation in engine configurations, e.g. through manufacturing diversity and wear. For example, frequency shift can be bounded based on typical allowable tolerances for idle speed. Amplitude limits can be set so as to minimize the effect of signal clipping.

Next, the set of clips resulting from the splitting and augmentation processes can be further processed by converting into multiple data types. In some embodiments, the raw, split, augmented data clips can be converted in one or all of several manners: Fast Fourier Transform (FFT), Mel-frequency Cepstral Coefficients (MFCCs), Spectrograms, and Wavelets. Converting into these features can give neural network models (whether Cascading or Parallel) a diverse set of inputs. The raw waveform provides the model with time information, while the FFT provides the model with frequency information. MFCCs, Spectrograms, and Wavelets provide the model with varying degrees of hybrid time and frequency information at different dimensionality.

### Example Implementations

The techniques and algorithms described above may be implemented via a variety of system arrangements, to be deployed via equipment operated by manufacturers, vehicle/equipment owners, mechanics or service providers, etc.

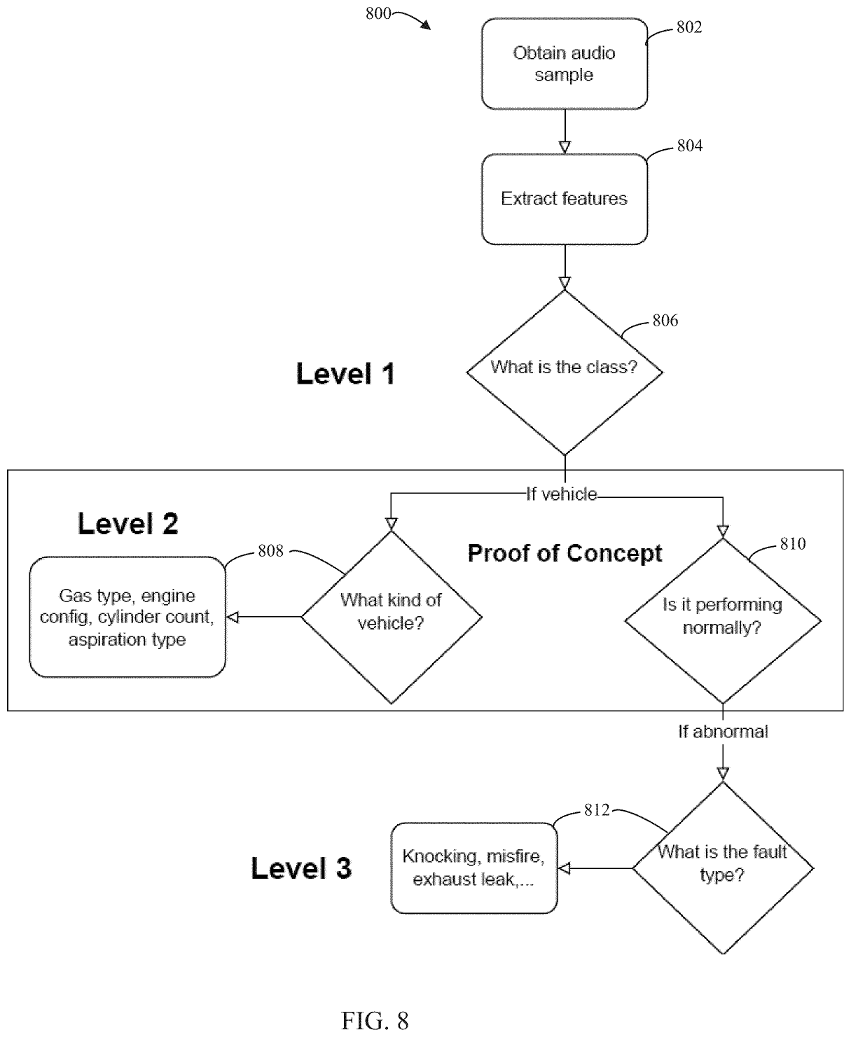

For example, the Cascading model and the Parallel model shown in FIGS. 7 and 8 are demonstrated on cars. However, it should be appreciated that the Cascading approach and the Parallel approach can be used in other vehicles, for other engine or industrial applications, or other suitable areas. For example, the Cascading approach can be used for applications where there is potential for inter-label dependency. For example, some systems that may utilize inter-label dependency in audio processing tasks may include music recognition—music recognition can involve hierarchies and label dependency, such as in a first stage determining (via a neural network for first stage of a neural network) ‘does the sample contain music?.’ Then a subsequent network or stage can be conditional upon the first stage, such that it could look to predict genre, artist, song, etc.

Not only can the Cascading architecture be extended to other audio applications, but also applications with other modes of data such as in computer vision. For example, biometrics could first ascertain whether a sample contains a valid fingerprint, iris, or facial scan. Then conditionally upon the first level, it could then ask whether the biometrics scan represents a valid user, what condition the user is in, perhaps using multi-modal data such as heart rate or blood pressure prediction. Another particularly relevant example in the larger vision field is autonomous vehicles (AVs). These systems are fusing many modes of data from sensors and making certain the state of the AV would be crucial. A Cascading neural network approach could follow a similar hierarchy as noted above: first, does a sample contain an AV, what are the attributes of the AV, is the AV behaving normally, and if not what fault behavior is the AV? The sample may comprise an image or video sample (which could, e.g., be from a traffic light, security camera, drone, etc. which is monitoring vehicle movement/traffic, or from the AV itself), or may be multi-modal data including vibroaccoustic data, image data, and other sensor outputs from the AV or remote sensors.

Another area for use of a Cascading architecture could be object recognition in images, such as animal recognition. For example, a sample may contain an image of an animal. A first network or stage of a network could determine whether the image contains an animal. Then, a subsequent stage or network could be conditional upon the first stage such that it could predict what kind of animal is in the image, what state the animal is in, what location the animal is in, whether the animal behaves normally, etc.

Another example application area for these techniques is broader fault identification, particularly using audio data. This can include other diagnostic areas, such as for industrial processes or energy sector equipment. One such example is home or industrial heating and ventilation systems: in this case, the first stage can be whether a sample contains ventilation equipment using acoustic classification networks. Then, the next stage can obtain its operating state and condition. If it's behaving normally, what is expected remaining useful life? If abnormal, what is the fault type and degree? For example, in some embodiments, a mobile application may be provided to a user for diagnostic use for an HVAC or other system. The application may provide information on status of the equipment, as well as recommend various maintenance tasks be performed and/or replacement parts be purchased (e.g, new filters, cleaning, motor service, etc. can be recommended to the user).

This Cascading architecture can be extended to other applications where a mechanical fault might occur. Some of these may include home appliances (washer/dryer) with belt slipping or drum imbalance, electric cars/bicycles with suspension issues, manufacturing equipment (CNC mills/lathes) with tool run-out or spindle issues, drills with brush wear or belt slip, the energy sector with turbine and pump health, elevator/escalators condition, and even carnival/fair equipment. It should be appreciated that the Parallel approach can also be used in application areas described above.

In one embodiment, a mobile app may be provided for user or mechanic usage, to diagnose status and fault conditions of a vehicle or other equipment. Software stored on the mobile device (or a remote server connecting to the mobile device) can provide a user interface that prompts the user to place the mobile device in a location where it can acquire audio and/or vibration data of the vehicle/equipment to undergo diagnostics. The software may then prompt the user to operate the vehicle/equipment in a number of states (e.g., starting, idle, acceleration, highway driving, etc.) that maximize the types of audio/vibration signals that will provide relevant information to the neural network. In other embodiments, the app may be granted permission to persistently acquire data whenever the user is in the vehicle and/or when a neural network detects the presence of vehicle audio. Once sufficient data has been acquired, the software may present a report of (1) remaining usable life of the vehicle and/or components of the vehicle (e.g., tire wear, filter life, etc.); (2) any likely fault conditions detected; and/or (3) recommendations for service, maintenance, and part replacement.

In another embodiment, a diagnostic device may be provided that comprises a vibration sensor, microphone, and other sensors such as optical camera and multi-axis acceleration sensor. The device may be integrated into the vehicle/equipment itself, or sold as a kit or aftermarket device. The device may sense operation of the vehicle/equipment and transmit the raw data to a remote computing resource or may process the data via a neural network as described above and simply transmit results to a remote device such as a user's mobile device, user's email, or a manufacturer.

Various designs, implementations, and associated examples and evaluations of a system for precision conservation through reduction of greenhouse gas in agricultural operations are described above. However, it is to be understood the present invention has been described in terms of one or more preferred embodiments, and it should be appreciated that many equivalents, alternatives, variations, and modifications, aside from those expressly stated, are possible and within the scope of the invention.

What is claimed is:

1. A method for diagnostic and condition monitoring of a system using context-based diagnostic and prognostic model selection, the method comprising:
receiving data from one or more sensors, the data associated with the monitored system;
determining an identification of the system based on at least the received data;
selecting an instance-specific diagnostic model based on the identification;
determining a system context based on at least the received data;
selecting a context-specific diagnostic model based on the system context; and
applying the selected instance-specific diagnostic model and context-specific diagnostic model to determine diagnostics and conditions of the monitored system.

2. The method according to claim 1, wherein determining the system context comprises determining a plurality of system contexts.

3. The method according to claim 2, further comprising repeating the step of selecting the context-specific diagnostic model for each of the plurality of determined system contexts.

4. The method according to claim 1, wherein the system is a vehicle.

5. The method according to claim 1, further comprising generating a report based on the application of the selected instance-specific diagnostic model and context-specific diagnostic model.

6. The system according to claim 1, wherein the one or more sensors are configured to acquire vibroacoustic data.

7. The method according to claim 6, wherein the one or more sensors includes a microphone.

8. A method for diagnostic and condition monitoring of a system, the method comprising:
receiving data from one or more sensors, the data associated with the system;
generating an audio feature based on the data;
inputting the audio feature into a neural network model; and
receiving one or more attribute predictions and a state prediction from the neural network model.

9. The method according to claim 8, wherein the system is a vehicle.

10. The system according to claim 8, wherein the one or more sensors are configured to acquire vibroacoustic data.

11. The method according to claim 8, wherein the audio feature is one-dimensional feature or two-dimensional feature.

12. The method according to claim 11, wherein the one-dimensional feature is a Fast Fourier Transform (FFT) feature, a waveform feature, or a wavelets feature, and wherein the two-dimensional feature is a spectrogram feature or a Mel-frequency Cepstral Coefficients (MFCCs) feature.

13. The method according to claim 12, wherein the neural network model comprises a first layer with a convolutional kernel size of 80 for the one-dimensional feature, and
wherein the neural network model comprises other layers with a convolutional kernel size of 3 for the one-dimensional feature.

14. The method according to claim 12, wherein the neural network model comprises a first layer with a convolutional kernel size of 2×2 for the MFCCs feature.

15. The method according to claim 12, wherein the neural network model comprises a first layer with a convolutional kernel size of 3×3 for the spectrogram feature.

16. The method according to claim 8, wherein the neural network model comprises a two-stage convolutional neural network (CNN),
wherein a first stage of the two-stage CNN receives the audio feature and produces the one or more attribute predictions, and
wherein a second stage of the two-stage CNN receives the audio feature and the one or more attribute predictions and produce the state prediction.

17. The method according to claim 16, wherein the second stage of the two-stage CNN receives a concatenation of the audio feature and the one or more attribute predictions.

18. The method according to claim 8, wherein the neural network model comprises a combined convolutional neural network (CNN),
wherein the combined CNN receives the audio feature and produces the one or more attribute predictions and the state prediction.

19. The method according to claim 8, wherein the one or more attribute predictions comprise at least one of: a fuel type, an engine configuration, a cylinder count, or an aspiration type.

20. The method according to claim 19, wherein the fuel type is indicative of gasoline or diesel,
wherein the engine configuration is indicative of flat configuration, inline configuration, or Vee configuration,
wherein the cylinder count is indicative of 2, 3, 4, 5, 6, or 8, and
wherein the aspiration type is indicative of normal aspiration or turbocharge aspiration.

21. The method according to claim 8, wherein the state prediction is indicative of a normal state or an abnormal state.

22. A system for diagnostic and condition monitoring of a vehicle, the system comprising:
one or more sensors;
a memory; and
a processor coupled to the one or more sensors and the memory, the processor configured to:
receive data from one or more sensors, the data associated with the monitored system;
generate an audio feature based on the data;
input the audio feature into a neural network model; and
receive one or more attribute predictions and a state prediction from the neural network model.

23. The system according to claim 22, wherein the audio feature is a one-dimensional feature or two-dimensional feature.

24. The system according to claim 23, wherein the one-dimensional feature is a Fast Fourier Transform (FFT) feature, a waveform feature, or a wavelets feature, and
wherein the two-dimensional feature is a spectrogram feature or a Mel-frequency Cepstral Coefficients (MFCCs) feature.

25. The system according to claim 23, wherein the neural network model comprises a first layer with a convolutional kernel size of 80 for the one-dimensional feature, and
wherein the neural network model comprises other layers with a convolutional kernel size of 3 for the one-dimensional feature.

26. The system according to claim 23, wherein the neural network model comprises a first layer with a convolutional kernel size of 2×2 for the MFCCs feature.

27. The system according to claim 23, wherein the neural network model comprises a first layer with a convolutional kernel size of 3×3 for the spectrogram feature.

28. The system according to claim 22, wherein the neural network model comprises a two-stage convolutional neural network (CNN),
wherein a first stage of the two-stage CNN receives the audio feature and produces the one or more attribute predictions, and
wherein a second stage of the two-stage CNN receives the audio feature and the one or more attribute predictions and produce the state prediction.

29. The system according to claim 28, wherein the second stage of the two-stage CNN receives a concatenation of the audio feature and the one or more attribute predictions.

30. The system according to claim 22, wherein the neural network model comprises a combined convolutional neural network (CNN),
wherein the combined CNN receives the audio feature and produces the one or more attribute predictions and the state prediction.
